(19) United States
(12) Patent Application Publication
(10) Pub. No.: US 2023/0085966 A1
(43) Pub. Date: Mar. 23, 2023

(54) METHOD, APPARATUS, DEVICE AND SYSTEM FOR THE GENERATION OF ELECTRICITY

(71) Applicants: Suneel Navnitdas PAREKH, Mumbai (IN); SU-N ENERGY HOLDINGS LTD., Toronto, Ontario (CA)

(72) Inventors: Suneel Navnitdas PAREKH, Mumbai (IN); Navnitdas Radhakishan PAREKH, (US); Platina Suneel PAREKH, Mumbai (IN)

(21) Appl. No.: 17/905,216

(22) PCT Filed: Jun. 1, 2021
(86) PCT No.: PCT/EP2021/064660

§ 371 Date: Aug. 29, 2022

(30) Foreign Application Priority Data
Jun. 24, 2020 (IN) 202021026656

(51) Int. Cl. G21G 7/00; G21H 1/04; G21B 1/13; G21B 1/21; G21B 1/17

(52) U.S. Cl. CPC G21G 7/00; G21H 1/04; G21B 1/13; G21B 1/21; G21B 1/17

(57) ABSTRACT

Electric An Electric Power Generation System generates electric power by capturing energy released from transmutation/conversion of one or more chemical element(s) into one or more other element/s, using any one or more elements of the periodic table. The captured energy is converted into electricity in a rector. The system preferably includes a transmutation reactor and an energy capturing system coupled to the reactor that converts captured energy into electricity, and connecting the electric energy to the electric grid or uses it on site power generation. In particular, the energy released in the of transmutation process is directly converted into electric power. Preferably, transmutation products that emerge in the form of charged particles, X-rays and heat, release energy removed from the fusion product ions as they spiral past electrodes of an inverse cyclotron converter.

### CROSS REFERENCE TO RELATED APPLICATIONS

This application is a national stage application of international patent application PCT/EP2021/064660, filed Jun. 1, 2021, designating the United States and claiming priority from Indian patent application IN202021026656, filed Jun. 24, 2020, and the entire content of both applications is incorporated herein by reference.

### TECHNICAL FIELD

The present invention relates to methods, apparatus, device and systems for production of electricity.

The present disclosure relates generally to the field of chemistry, physics, particle physics, engineering, electrical engineering, nuclear physics, nuclear engineering and, in particular, to methods, apparatus, device and system for production of electric power by capturing of energy released by transmutation of one chemical element into another element/s, using any one or more target elements of the periodic table. Paramagnetic and excited state mercury-based compound is used as a source of energy for transmutation of elements and generation of energy. During the transmutation process, there is energy released in the form of charged particles, X-rays and heat. Released energy is captured and converted for production of electricity to meet demand supply gap of electricity and for providing better quality of life for masses and other applications of electricity and fuel for transportation.

### BACKGROUND

Nature has given us infinite energy in the form of Sun, by transmutation of hydrogen elements, since world come into existence. The Sun energy makes all life possible on earth.

The world's population is expected to grow to 9 billion by 2040, driving global demand for electricity up by 45%. Meeting this demand with the technologies available today will require that fossil fuels remain a primary means of electricity generation. To sustain economic growth while at the same time overcoming climate change, we need to develop sources of energy that are emission-free, safe, globally available and economically viable.

Transmutation process has the unique capability to provide utility-scale energy on-demand wherever it is needed, making it an excellent complement for intermittent renewables and battery storage. Combined, these technologies make for a practical energy portfolio that mitigates climate change while driving economic prosperity.

Nuclear transmutation is in an ideal position to replace coal, oil and gas fired power plants around the world. Transmutation of elements has no carbon footprint, except that carbon which is produced during construction and manufacture of the plant. The fuels of transmutation such as hydrogen, deuterium, lithium, boron are abundant in nature or can be manufactured with little cost. The isotope deuterium occurs naturally and can be found in sea water in abundance.

Nuclear transmutation is the conversion of one chemical element or its isotopes into another. In other words, atoms of one element can be changed into atoms of other elements by transmutation. This occurs either through nuclear reaction, in which an outside particle reacts with a nucleus, or through radioactive decay, where no outside particle is needed.

### SUMMARY

For this reason it is an object of the invention to provide a method, apparatus, device and system for the generation of electricity, which will be cost effective, inexhaustible source of clean, safe, carbon free and zero emission energy. This will be able to fulfill the demand of global energy needs, with complete respect of our environment and the population.

This object is satisfied through the generation of electricity as per method, apparatus, device and system described herein.

The method, apparatus, device and system comprises the steps and equipment as follows:
Vacuum chamber melting with vacuum level up to 10⁻³ bar
eating arrangements and crucible for melting of target elements
Paramagnetic and excited state mercury-based compound as a source of energy for transmutation of elements and production of electricity
Target elements any one or more elements of the periodic table from hydrogen to uranium and transuranic elements.
Inlets, outlets and Divertor
Conversion system for X rays/photon/Electromagnetic consists of capturing of X-rays released during transmutation and converting it into electricity
Conversion system for charged particles energy consists of capturing of charged particles released during transmutation and converting it into electricity
Conversion system for heat released during transmutation and converting it into electricity
Cooling system
Capacitors
Transformer
Photoelectric converter
Heat exchanger
Control valve and control system
Pressure valves to measure reactor pressure.
Shielding room
Remote mechanism to operate
Room to operate plant.
Technology to convert energy into electricity
Capacitor bank to store electricity and fed it to grid, off grid and onsite applications

Vacuum reactor chamber pressure vessel of stainless steel with pressure control device. Vacuum chamber with inlets/outlets having pressure capacity and volume of target elements, such as 1 g Hydrogen in the form of gas, liquid, pallets or in combination thereof but not limited to it.

Paramagnetic, excited state mercury-based compound is used as a source of energy, System of heating, temperature controller, Valve to control gas inlet/outlet, Shielding room, re mote mechanism, Conversion to convert a, b, x and heat into electricity. cooling system.

2 g of Hydrogen gas=1 mole=22.4 L at STP (STP=Standard Temperature and Pressure)

10 g of Hydrogen gas=5 mole=112 L at STP

High temperature Crucible holding target elements and merucury-based compound, which is paramagnetic and present in the excited state.

Putting target elements in the form of gas or solid or liquid and adding excited state mercury-based compound inside close container/crucible;

Slowly heating target elements over its melting point or critical point, at which point excited state mercury-based compound reacts with nucleus of the target elements, transmuting target element in a reaction chamber, temperature taken over the melting temperature of target element, measuring temperature, pressure and energy released during transmutation process from room temperature to the temperature required to melt the target elements up to 1700 C, but not limited to it.

Outlet for gases released during transmutation process in the form of helium, tritium, etc and its analysis on line for helium, tritium.

During the transmutation process, there will be X-ray radiation emits in the different energy ranges e.g., 100 eV-40 keV and above.

X-rays make up X-radiation, a form of electromagnetic radiation. Most X-rays have a wavelength ranging from 0.01 to 10 nanometers, corresponding to frequencies in the range 30 petahertz to 30 exahertz (3×1016 Hz to 3×1019 Hz) and energies in the range 100 eV to 100 keV.

Targety elements will be Hydrogen gas, deuterium gas, lithium hydride, Lithium metal, Deca boron gas, Boron polymer, Boron metal, CO2 gas, NO2 gas, or any one or more element of periodic table in solid, liquid, gaseous and molten state.

Photoelectric converters are composed of X-ray absorber and electron collector sheets nested concentrically. Indeed, since X-rays can go through far greater thickness of material than electrons can, many layers are needed to absorb most of the X-rays with an overall efficiency of over 80% for the photoelectric conversion scheme.

Direct conversion of transmutation products into electricity will be a huge reduction in costs and will be inexhaustible, Safe, clean and carbon free source of electricity.

Using Mercury-based Compound as a source of energy, wherein mercury based compound is paramagnetic and present in the excited.

Target elements will be any one or more elements of the periodic table from hydrogen to uranium and transuranic elements.

Mercury based compound will transmute target elements into many new elements in the range of 1% to 100%, depends on the target material (Endothermic and Exothermic reaction) and will generate energy in the form of charged particles, X-rays and heat, which will be many times of two hydrogen nuclei fusion. The released energy of transmutation products will be captured and converted into electricity using capacitor, transformer, photoelectric converter and heat exchanger.

The technology will transmute lighter target elements such as H, D, Li, B, Al and heavier elements such as fissile actinides, non fissile Actinides and Transuranic elements into many new elements and releases energy many times of fusion reaction. The released energy of transmutation products will be captured and converted into electricity using capacitor, transformer, photoelectric converter and heat exchanger

In the fusion of two hydrogen nuclei to form helium, 0.7% of the mass is carried away from the system in the form of kinetic energy or other form of energy (such as Electromagnetic radiation). Whereas in the present invention there will be energy released in the form of kinetic energy or other form of energy (such as electromagnetic radiation), which will be many times of 0.7 of hydrogen fusion energy

Any heavier elements including of long-lived radioactive target elements can be transmuted into short-lived or stable elements and during the transmutation process there will be energy released in the form of charged particles, X-rays and heat, which will be used for production of electricity.

Using mercury-based compound as a source of energy, wherein fabricated mercury based compound is paramagnetic and present in the excited state (based on PCT Publication number: WO 2016/181204 A1), which will react with target elements and will transmute target elements into many new elements. During the transmutation process, the mass is carried away from the system in the form of kinetic energy or other form of energy (such as Electromagnetic radiation), which will be many times more than fusion of two hydrogen nuclei.

Transmutation process converts the target elements into many new elements and results in the removal of energy when nucleus is formed, and this energy has mass, mass is removed from the nucleus. This missing mass is known as mass defects and represents the energy released when the nucleus is formed.

Fabrication of Mercury-based Compound and using it as a source of energy (based on Prior art PCT Publication number: WO 2016/181204 A1), wherein fabricated mercury-based compound is paramagnetic, present in the excited state and capable of transmuting elements and using fabricated mercury-based compound with target elements, e.g., (any one or more elements/isotopes of the periodic table) for transmutation of elements and generation of energy for production of electricity and applications of electricity and fuel for transportation.

Resultant transmuted products will have missing mass in the form of energies (mass defect), which will be directly converted into electric power without steam cycle. Preferably, during the transmutation process, there is energy released in the form of Charged particles, X-rays and heat. Released Energy from transmutation process is captured and converted into electricity. Advantageously, the energy conversion system include target elements, paramagnetic and excited state mercury-based compound as a source of energy, which reacts with nucleus of the target elements and releases energy in the form of Charged particle, X-rays and heat. Direct energy pickup from the transmutation of elements and generation of electricity.

Only direct conversion of mass into energy is more energetic per unit of mass than nuclear fusion.

The present inventors recognized a need for compact and cost effective method, device, apparatus and system that produces charged particles, X-rays and heat. Based on target elements, the transmutation technology releases energy in the form of charged particles, X-rays and heat. There is no neutron released in the transmutation process based on target elements used for transmutation process. This is extremely important because:

Neutrons are destructive to material structures. If you do not have any neutrons, then all the problems associated with neutron radiation is completely eliminated such as ionizing damage, neutron activation, biological shielding, remote handling and safety.

Neutrons produce radioactivity by merging with other nuclei and generate unstable or radioactive materials. No neutrons, no radioactive wastes.

Advantages of the present invention for generation of electricity as follows, i.e.

Clean, Safe, Carbon free Sustainable, and Zero emission.

No greenhouse gases, No fuel spillage, No radioactive waste, No pollution It doesn't emit harmful toxins like carbon dioxide or other greenhouse gases into the atmosphere.

Off Grid, Onsite power generation, and not dependent on any weather conditions,

Power on-demand using existing grid infrastructure .

Power can be made available to remote places, where Grid infrastructure is not available.

It is more economical and needs less land than other renewable technologies.

In addition, some embodiments include an X-ray energy converter for directly converting the X ray emission into electricity energy. The X ray energy converter for directly converting the emission of one or more x-ray bursts into electrical energy is in communication with an X-ray burst source and the energy storage unit. The X-ray energy converter for directly converting X-ray emissions into electricity energy. The Collector includes one or more electron emitter layers in electrical communication with one or more electrons collector layer. The one or more electron emeiiter layers absorb the one or more X-rays and emits electrons that are absorbed by the one or more electron collector layers.

Furthermore, a method of converting energy released from transmutation of target elements into electrical energy is provided by the present invention. The method includes using an X-ray energy converter and charged particles converter to capture the X-ray and Charged Particles energy, convert them into electrical energy and store the electric energy in storage devices.

The present invention are discussed in detail below, it should be appreciated that the present invention provides many applicable inventive concepts that can be embodied in a wide variety of specific context. The terminology used and specific embodiment discussed herein is merely illustrative of specific ways to make and use the invention and do not delimit the scope of the invention.

To facilitate the understanding of this invention, a number of terms of defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration . The terminology herein is used to describe specific embodiments of the invention, but their usage does not delimit the invention.

The present invention is directed to a system that facilitates controlled transmutation of elements and the direct conversion of transmutation product energies to electric power. The system, referred to herein as a Electric Power Generation System, preferably includes a reactor having a containment system that tends to substantially reduce or eliminate anomalous transport of ions and electrons. In addition, the Electric Power Generation System includes vacuum reactor, melting furnace, target elements, paramagnetic and excited state mercury-based compound as a source of energy for transmutation of target elements, an energy conversion system coupled to the reactor that directly converts transmutation product energies to electricity with high efficiency.

Target elements such as hydrogen, deuterium, lithium, boron are available in all parts of the world,

The energy released in the form of charged particles. This charged particle goes into a form of a high-tech transformer, capacitors, which collects the energy and converts it into a electric circuit.

The energy released in the form of X-ray, which are captured by photoelectric receptors. They collect the energy and again convert it into electricity.

There will be efficiency of over 80% for conversion of energy into electricity.

The electricity produced by present invention will be much cheaper than the large and complex steam turbines being used for production of electricity.

Paramagnetic and excited state Mercury-based Compound is used as a source of energy (based on Prior art PCT Publication number: WO 2016/181204 A1) and reacted with target elements (any one or more elements of the periodic table), for transmutation of target elements and generation of energy, which will be converted into electricity.

Electricity production device of the present invention can be from kilowatts to Gigawatts, but not limited to it. It will be grid and off grid for all kinds of electricity applications such as for Residentials, Commercials, Industrials, Agricultures, Desalination of water, Office, Sport complex, Entertainment, Medical Hospitals, Engineering, Transportation, Universities, Communication, Outdoors, Spacecraft, Rockets, fuel and so on.

A direct energy conversion system is used to convert the kinetic energy of the transmutation products directly into electric power by slowing down the charged particles through an electromagnetic field. Advantageously, the direct energy conversion system of the present invention has the efficiencies, particle-energy tolerances and electronic ability to convert the frequency and phase of the fusion output power to match the frequency of an external 50/60 Hertz power grid.

Electrostatic direct conversion uses charged particles motion to make a voltage, this voltage drives electricity in wire, the becomes the electrical power.

Direct energy conversion system converts a charged particle's kinetic energy into voltage.

Direct conversion techniques can either be inductive based on changes in magnetic field, Electrostatic based on making charged particles work against an electric field or, photoelectric, where light energy is captured

Microwave technology can directly convert charged particles energy into electricity

High tech transformer to convert charged particles into electricity.

Electrostatic motor power and propulsion using potential energy of charged ions into electricity.

Ion thrusters using potential energy of charged ions into electricity.

Ion propulsion using potential energy of charged ions into electricity.

Electrostatic Ion thrusters using potential energy of charged ions into electricity.

Using Ion collector as a positive potential and Electron reflector Grid as a negative potential for generation of electricity.

Most of the energy is released in the form of charged particles This charged particles is fed to type of induction coil. The charged particle generates changing magnetic field, which in turn generates current in coil. This pulse of current is fed to capacitor; and is fed out to Electrical Grid.

Photoelectric where light energy is captured. X-rays colloid with electron thin metal thin, Causing electrons to be emitted with high energy. Electrons are captured on charged electrical grid, Generating current. This current is fed into Grid

Heat energy will be captured and will be converted into electricity by heat exchangers.

The X rays pulse energy is converted into electric energy by a multilayer photoelectric convertor. The X-ray photons collide with electrons in thin foil, giving the electron energy, which can be collected on grids. This charges a capacitor. The energy flows out to a DC-AC convertor, which then feeds it into the electric power network.

The heat produced by the transmutation reaction is captured by a heat chamber around the reactor containments and can be used to power turbines, heat engine, or other heat suitable device.

The above-mentioned and other features and advantages of this invention, and the manner of attaining them, will become more apparent and the invention will be better understood by reference to the following description of an embodiment of the invention taken in conjunction with the accompanying drawings, wherein:

The target elements can be any one of periodic table from hydrogen to uranium and transuranic elements. For example lighter elements such as hydrogen, deuterium, tritium, lithium, boron or heavier elements such as fissile actinides, non fissile actinides and Transuranic elements or in combination thereof.

Paramagnetic and excited state mercury-based compound will be used as a source of energy for transmutation of elements and generation of energy.

### BRIEF DESCRIPTION OF DRAWINGS

The disclosure will now be described with reference to the drawings wherein:

FIG. 1 is a schematic of the overall circuit of the method, apparatus, device and system for generation of electricity;

FIG. 2 is a schematic of an energy capturing system;

FIG. 3 is a schematic of the energy conversion of X-rays;

FIG. 4 is a schematic of the overall X-ray collector;

FIG. 5 is a schematic of the charged particle collector;

FIG. 6 is a diagram of the coolant system of the X-ray collector; and

FIG. 7 shows ESR Analysis results performed by IIT Bombay INDIA for Mercury based compound.

### DESCRIPTION OF EXEMPLARY EMBODIMENTS

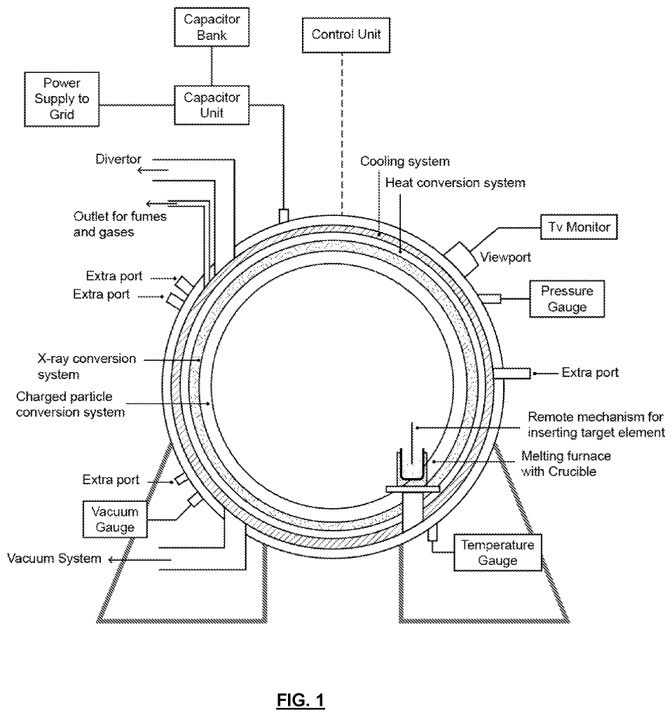

FIG. 1 is a schematic of the overall circuit of the method, apparatus, device and system for generation of electricity. The overall circuit includes vacuum reactor, vacuum system, A melting furnace with crucible wherein target elements will react with paramagnetic and excited state mercury compound for transmutation process is to take place. This energy released during transmutation in the form of X-rays, Charged Particles and Heat will be in communication with the charged particle conversion system, X-ray conversion system, Heat conversion system for production of electricity. The Electricity Generation device is connected to a capacitor unit, which is connected to a capacitor bank and to the power grid. The Electricity Generation device is also connected to a control unit, viewport, pressure gauge, temperature gauge, vacuum gauge, fume outlets and divertor. The skilled person will recognize that there are many different configurations of the present invention, and the present figure is but one of many contemplated by the inventors.

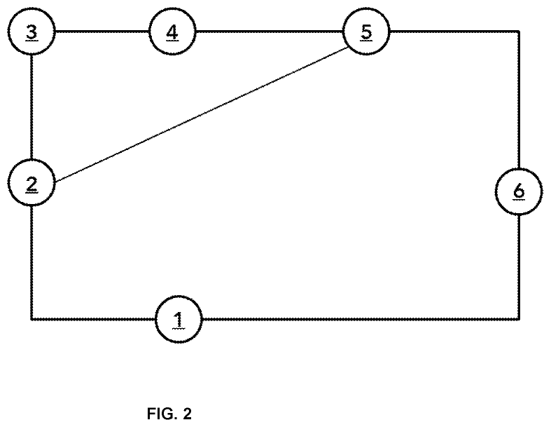

FIG. 2 is a schematic of an energy capturing system. The transmutation energy device 1 of the present invention is connected to a first switch 2 and a second switch 6. Both the first switch 2 and second switch 6 are connected to a main capacitor bank 5. The main capacitor bank 5 may contain one or more capacitors arranged in banks or may contain one or more capacitors arranged in multiple banks, which are in turn arranged in banks of capacitors. The first switch 2 is also connected to a second capacitor bank 3. Both the capacitors are connected to the X-rays pulse 4.

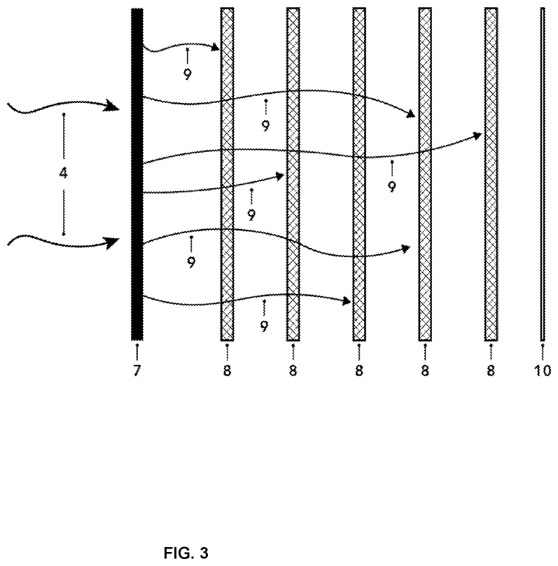

FIG. 3 is a schematic of the energy conversion of X-rays. The X-rays pulse 4 can be converted at high efficiency to electricity via the photoelectric effect. The converter is essentially a capacitor with multiple layers of thin metal films. One type of film, type A film 7 serves as the emitter of one or more electrons 9, converting the energy from the X-ray 4 to that of multi-KeV electrons 9. The type A film 7 also serves as the ground electrodes of the capacitor. A second type of film, type B film 10, serves to collect the emitted electrons 9 and act as the cathode electrode 8 of the capacitor. In a single layer, X-rays 7 impinge on metal type A film 7, causing the emission of electrons 9 with range of energies. These electrons 9 travel through a series of voltages by an external circuit. When the electrons 9 approach an electrode 8 charged to a greater voltage V than their energy in electron volts, they turn back and are absorbed by the next adjacent electrode 8. For high efficiency in converting the energy of the X-rays 4 into the energy of the electrons 9, the converter design must ensure that nearly all the X-rays 4 are absorbed in type A film 7 and that very little of the electrons energy is absorbed before leaving type A film 7. In addition, X-rays absorbance in thin type B film 10 must be minimised by suitable choice of material.

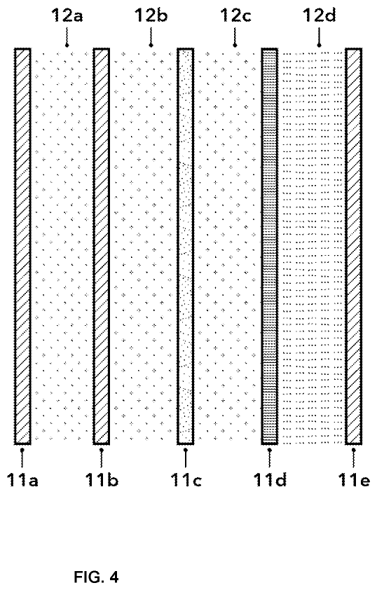

FIG. 4 is a schematic of the overall X-ray collector. The X-ray collectors 8 include one or more metal layers 11a-11e separated by interstitial layers 12a-12d. The composition of the one or more metal layers 11a-11e may vary depending on the specific embodiment. For example, metal layers 11a, 11b and 11e containing aluminium metal, layer 11c containing copper, while metal layer 11d containing tungsten. Similarly, the composition of the interstitial layers 12a-12d may vary depending on the specific embodiment. For example, interstitial layers 12a, 12b and 12c may be aluminum or beryllium, while 12d is tungsten. Although the skilled artisan will recognize the above examples are intended for illustrative purposes and that other metals may be used in different orders and compositions.

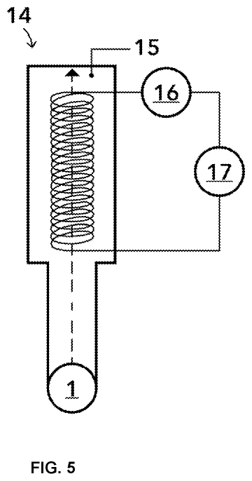

FIG. 5 is a schematic of the charged particle collector. The charge particles collector 14 is in communication with a gyrotron 15 to couple the charged particles efficiently to a RF pulse. In another embodiment, the charged particles collector 14 is in communication with a peniotron converter. A series of fast switches 16 activated by UV light, can be used to couple the RF pulse into fast storage capacitors, with the switch 15 opening when the capacitors 17 are charged preventing energy from flowing back into the resonator. The charged particles spread in flight, but still has a short pulse length when it arrives at the gyrotron 15 creating a rapidly varying magnetic field, making it easier to optimize an efficient design to couple the energy into a circuit. The high power of the charged particles collector 14 requires careful design of the circuit to link the transfer of power into capacitors 17 at reasonable potentials.

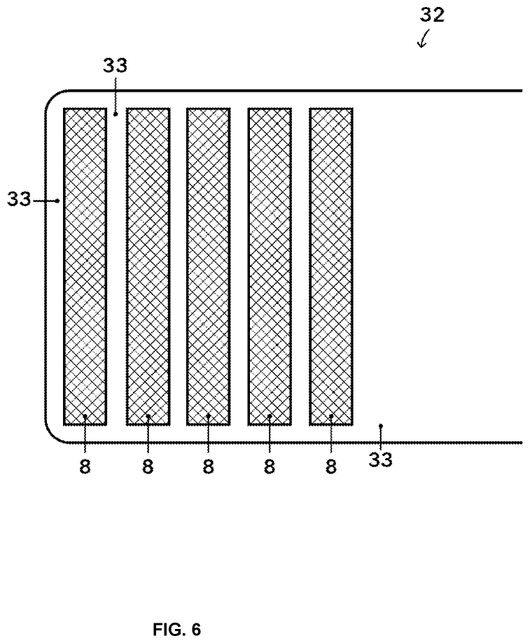

FIG. 6 is a diagram of the coolant system of the X-ray collector. Since the charged particles energy conversion system has a large surface area and the residual heat is distributed within it, cooling it is relatively simple. In the case of the X-rays conversion system 32, however, care must be taken to avoid blocking the X-rays or electrons with the coolant itself by passing an electrically non-conducting coolant, e.g. silicone, through several dozen very narrow pair of conduits 33, all oriented radially toward the transmutation device. The X-rays collector 8 is made up of one or more metal layers (not shown) and interstitial layers (not shown) are separated by conduits 33. If the coolant plates have a typical separation of a few tens of microns, they absorb less than about 1% of the radiation, but are still able to carry adequate coolant flow to remove few MW of waste heat from the X-ray conversion devices. The coolant plates, running radially through the device every several degrees can also serve to give mechanical support to the thin film electrodes.

The target elements will be hydrogen, deuterium, lithium, boron or any one or more elements of periodic table from hydrogen to uranium and transuranic elements. Transmutation of target elements will produce only charged particles, X-rays and heat. All released energy of charged particles, X-rays can easily be converted into electricity with about 80% efficiency.

The Method, Apparatus, Device and System for the Generation of Electricity comprises one or more of the following equipment, i.e.
Reactor chamber Vacuum vessel made of stainless steel having volume of 1000 Itr capacity but not limited to it.
Capacity depends on the target element volume—holds the target elements and keeps the reaction chamber in a vacuum
Outlet System—Outlets for heat, fumes and gases released during transmutation process.
Divertors for exhaust the helium products of the fusion reaction, and harmless helium will be released into the atmosphere.
During the transmutation process, energy will be released in the form of charged particles, X-rays, and heat
Shielding room all safety devices and measuring equipments
Vacuum Reactor Chamber round conical 1000 L capacity 25 mm to 50 mm thick wall pressure valve in side chamber and measuring device
Target elements inlet 1 to 10 g in gaseous form, solid, liquid, molten or combination thereof, but not limited to it.
Paramagnetic and excited state Mercury-based Compound as a source of energy for transmutation of elements and generation of energy.
Inlet pipe nos with valve & control system.
High temperature heating furnace placed in vacuum reactor, having melting point of 1700 C with control system, depends on the melting point of target elements being used.

The Vacuum reactor chamber consists of spherical section 300 cm in diameter, 600 cm long , equipped with a hinged, 240 cm diameter end cap that serves as the main entrance port. A pneumatic clamping mechanism is used to seal the system, allowing quick and unobstructed access to the chamber interior. Another entryway is provided by a 90 cm diameter port outfitted by a hinged door, located at the side opposite to the main insertion port. Ten circular ports of diameter ranging from 64 mm to 500 mm are further available for diagnostic and alignment purposes, but not limited to it. The size of vacuum reactor will be based on target elements quantity and production of electricity from kW to GW.

It will be vacuum coupled to the master chamber or operated independently. When vacuum coupled, the separation of the targets can be adjusted to range from 60 cm to about 500 cm, using different lengths of vacuum bellows and/or solid tubing . The distance rearrangement is eased by a guideway system integrated in the floor, in which the cylindrical chamber may be displaced. In addition to the entry and vacuum ports.

In the chambers, all internal optics and target stage are mounted on a support frame, which is directly bolted to the floor and mechanically decoupled from the chamber walls with a counterbalanced bellows system

Fabrication of Mercury-based Compound and using it as a source of energy, (based on Prior art PCT Publication number: WO 2016/181204 A1), wherein fabricated mercury-based compound is paramagnetic, present in the excited state and capable of transmuting elements.

Using fabricated mercury-based compound with target elements, e.g (any one or more elements/isotopes of the periodic table) for transmutation of elements and generation of energy for production of electricity.

Vacuum reactor having Dimensions of 600 cm in length, 300 cm in diameter, but not limited to it. The melting furnace having temperature of 1700 C to melt target elements, but not limited to it.

Crucible holding capacity for target elements and high resistance can be of Graphite , alumina, magnesia or any other material depends on target elements having capcity of mg to kg but not limited to it.

Remote mechanism for inserting target elements and paramagnetic and excited state mercury based compound for reacting it with target elements for transmutation of elements and production of energy in the form of charged particles , X-rays, photons , kinetic energy and heat.

Released energy will be captured and converted into electricity by conversion system such as Capacitors and transformer for capturing charged particles and converting it into electricity. Photoelectric converter for capturing X-rays/photon/electro magnetic waves and converting it into electricity. Heat exchanger for capturing heat and converting it into electricity and Cooling system.

Capacitors will be used to store electricity, which will be fed into Grid via transformer and can be used directly for off grid applications of electricity.

The vacuum vessel is penetrated in a number of places by maintenance ports, either at the upper, equatorial or divertor level. The ports are shown in Figure and examples of the plugs that close them are shown in Figure. The divertor ports allow access to the divertor region of the device, and are large enough to allow the removal and replacement of divertor cassettes. The equatorial ports lie around the equatorial mid-plane of the device. These ports typically contain equipment for the heating and diagnostic systems.

Port plugs must stem the flow of released energy through them so that the shutdown photon dose after 14 days is less than 100 pSv hr-1 behind the plug, so that the port interspace area does not get excessively activated. The 100 pSv hr-1 after 14 days limit is an ITER requirement and is a voluntary target resulting from safety factor targets. In the majority of cases the front surfaces of the port plug match the surrounding geometry of blanket modules. The ports can contain heating and diagnostic systems .

The first major section is the vacuum chamber. The vacuum chamber is where all of the other systems meet and where transmutation takes place. The chamber is metallic, stainless steel is the best choice as it has a high heat resistance and will not corrode.

The vacuum port is the largest port and will be on the bottom of the chamber. This is for convenience, as this design will allow for the chamber to rest on top of the diffusion pump.

The high vacuum gauge port may be placed anywhere of convenience. It is used to measure the chamber's pressure.

The heating system having high temperature melting furnace temperature of 1700 C for melting of target elements.

The target elements port will be placed anywhere that is not directly beside the vacuum port, as this will lead to the waste of target elements.

The viewport should be facing a thick wall or be on an angle towards the ground as a cone shaped beam of x-rays will be passing through the glass, it should not be facing towards a thin wall or window.

Careful design comes into play when planning a layout for the vacuum chamber, the high heating system, viewport and vacuum port are the ports requiring the most attention. The chamber must have a stable and strong base to hold the chamber in place. The chamber should have a protective radio shielding to stop radiation. This must especially be applied to the view port, as this is where the most radiation will be emitted.

The purpose of the vacuum system is to reduce the chamber's pressure down to at least from 1 Torr to 10⁻³ Torr. The vacuum system consists of:

1. A gate or bellows valve which will separate the vacuum system from the chamber

2. Fore line/ roughing mechanical pump (Primary Pump) which will begin the vacuum process

3. A diffusion pump or turbo pump (Secondary Pump), a scientific pump that brings the vacuum down to it's ultimate lowest level

4. Throttle Valve, which will control the connection between the secondary pump and primary pump

5. High Vacuum tubing or a fore line pump connection, which will connect the secondary pump output flange to the fore line valve and Primary Pump inlet

The primary/fore line pump or roughing pump is a dual stage mechanical pump that must have a minimum pumping power of 5 Cubic Feet per Minute (CFM). The primary pump plumbs the vacuum pressure down to around 40 mbar/30 Torr, at this stage the secondary pump, which must be a fully functional diffusion or turbo pump is turned on and the chamber pressure reaches less than 1 mbar. At this point the needle valve is opened and the target elements gas starts filling the chamber causing the pressure rises to 5-15 mbar/3-11 Torr. Skilled operation takes place here as the operator must be sure to not put too much target elements into the chamber while also ensuring that he/she is not wasting it. If too much target elements is put into the vacuum chamber then the gate valve must be opened, re establishing dynamic equilibrium. This is why the gate valve is so crucial in a vacuum system.

The heating system having capacity to reach temperature over melting point of target elements, e.g., 1700 C , but not limited to it.

The inlet is the most simple out of all of the systems, the inlet is what supplies chamber with the target element to the chamber. The Inlet-line consists of following component

1. Pressure Regulator to regulates and measures the high pressure gas

2. Stainless Steel Capillary tube to limit the flow of gas

3. Needle Valve, the main control valve used to precisely regulate the flow of gas

4. Gas-Line fitting and adapter, which will connects the gas line capillary to the vacuum chamber

5. Inlet can be used for metal target elements in solid, liquid, gaseous or molten state

Although the Inlet system is simple, the sealing and flow rate, must all be met with precision. The reason for this being that the required pressure within the chamber must be 1*10⁻² torr, a very precise pressure. To meet this, a very low flow rate must be used as to not fill the chamber with target material too quickly, a flow rate of 1 Standard Cubic Centimeters/ Minute (SCCM) is ideal. Establishing a dynamic equilibrium is a much easier task when careful care is taken.

Heating will be monitored through the use of temperature meter within the high precision. Heating is a crucial factor when it comes to melting of target elements,

Vacuum Pressure is measured through the use of an ionization gauge, which is attached to the chamber. This gauge provides precise measurements in mbar/torr, allowing us to monitor the vacuum operation during air evacuation as well as during transmutation operation. Pressure is important as it prominently

Using the Reduced Pressure Electron Beam (RPEB) process for producing single sided butt welds in 60 mm thick 316L type austenitic stainless steel in a range of welding positions from flat position to overhead. The aim was to identify the maximum weld penetration depth or thicknesses of material, which could be welded satisfactorily in each welding position and for joining containment vessel sectors.

The vacuum turbo pump is installed, attach the inlet to a valve which then connects to the chamber and attach the mbar/Torr outlet to a mechanical backing pump capable of reaching at least around 75 mbar/56 Torr.

Turn on the mechanical pump and wait for the vacuum to reach at least 75 mbar. Next the high vacuum by turning on the boiler on the diffusion pump. After it warms up (could take a while), the vacuum will rapidly drop below the single mbar range.

The inner heating melting furnace having temperature range over melting point of target elements with crucible holding and base.This can be built as long as it resembles a spherical shape of roughly 3-30 cm in diameter, it will be accordingly quantity of target elements and its melting point, but not limited to it.

Hydrogen, Deuterium, lithium, boron: gas/liquid/solid/molten state or any elements of periodic table is used as the target element fuel for this reactor. High-pressure regulator is directly attached to the tank holding gas as target elements, an extremely fine-metering needle valve is added after this (or a laser drilled orifice in the range of 5 microns), and then it is attached to the chamber. A ball valve is also installed between the regulator and the needle valve since needle valves are not shutoff valves.

Heating system as per requirements appropriate for melting of target elements for transmutation process to take place, Gas out let attach to chamber, diverter attach to chamber, pressure valve, temperature controller,

The role of the blanket modules is to shield the vacuum vessel from recover heat and also to breed tritium using lithium components within the blanket module.

Tritium breeding blankets would be placed on the inside of the vacuum vessel,

The Divertor is placed at the bottom of the vacuum vessel, it is a component designed specifically to service high heat and particle fluxes. Particles that escape confinement are guided to the divertor where they strike ceramic or metallic plates known as strike plates. Some divertors require active cooling due to the large amounts of energy deposited, other divertors have a higher radiative cooling fraction by injecting a neutral gas in the region of the divertor, causing electrons to emit some kinetic energy in the form of Bremsstrahlung radiation. Besides providing shielding of the vessel, the modular cassettes support the divertor target plates, a set of components designed to withstand large heat fluxes, built with high conductivity armour of carbon fibre composite and tungsten.

There are a number of options that have been considered, however each subsystem has its own requirement and heat deposition rate. There are however three standard coolants namely water, Hydrocarbon material.

A sizable fraction of the energy released by transmutation process would not remain in the charged particles products but would instead be radiated as X-rays. Some of this energy will be converted directly to electricity. Because of the photoelectric effect, X-rays passing through an array of conducting foils would transfer some of their energy to electrons, which can then be captured electrostatically. Since X-rays can go through far greater thickness of material than electrons can, many hundreds or even thousands of layers would be needed to absorb most of the X-ray.

Electrostatic direct conversion uses charged particles motion to make a voltage, this voltage drives electricity in wire, the becomes the electrical power.

Direct conversion involves capturing charged particles to create a current. In this case the energy is never captured intentionally as heat. These systems are designed to create current directly. Direct conversion will achieve efficiency of 80% in the conversion of energy to electrical power.

in order to utilize direct conversion systems effectively, we need to be using a target elements, which will produce no neutron or very small number of neutron during transmutation process. This is because neutrons, lacking electric charge, can not be steered onto certain collection plates.

Direct conversion techniques can either be inductive based on changes in magnetic field, Electrostatic based on making charged particles work against an electric field, or Photoelectric where light energy is captured.

Microwave technology can directly convert charged particles energy into electricity

Photovoltaic power generation is quite popular, and its use is expected to grow further. It has many advantages such as the production of clean energy that can limit CO₂ emissions, the ability to harness the infinite power of the sun, the flexibility and ease to be scaled up to large power generation systems, and the recipient of government assistance.

Because of these advantages increased attention in this area has led to a greater efficiency of power generation, while manufacturing techniques of various photovoltaic cells made of single crystalline and polycrystalline materials and amorphous silicon have improved considerably. Therefore, the components of photovoltaic power generation systems have now become more readily available. However, there have been few reports on electric power generation with X-rays and gamma rays, although the energy generated by these rays is much larger than that generated by sunlight. In the medical field, the use of intensifying screens is well established and is an essential diagnostic technique that reduces unnecessary exposure of the human body to X-rays.

An intensifying screen plays the role of a wavelength converter; that is, an X-ray photon having a wavelength of less than 1 nm is converted into a visible light photon having a wavelength within the range of 400-800 nm. Recently ultrahigh-speed and extremely thick intensifying screens that can be used in indirect digital radiography and radiation treatment have become commercially available.

The X-ray energy converter may be separated from the reactor chamber by a thin wall of a suitable material such as beryllium: however the other materials may be used. The X-ray energy converter includes one or more capacitors in electrical communication with one or more electron emitter layers and one or more electron collector layers. The one or more electron emitter layers absorb the x-rays and emit electrons that are then adsorbed by one or more electron collector layers.=7 The X-ray energy converter may be a series of one or more x-ray energy converters positioned to collect x-rays of different energy levels. For example, the one or more x-ray energy converters may be nested concentrically with each x-ray energy converter having one or more electron emitter layers and one or more electron collector layers. Additionally, the x-ray energy converted may have one or more electron emitter layers or one or more electron collector layers in which some layers may be nested concentrically to collect x-rays of different energy levels. The one or more electron layers adsorb the x-rays and emit electrons that are then adsorbed by the one or more electron collector layers. Similarly , the one or more electron collector layers may be positioned to absorb emissions of different energy.

Generally, each of the one or more electron collector layers are separated by a voltage of between about 15 and about 25% relative to the next electron collector layer: however, the electron collector layers may be separated by a voltage of between about 10 and about 30% relative to the next electron collector layer depending on the particular application.

The anode and cathode may individually be constructed from a variety of materials, e.g. beryllium, copper, etc., which allows the high x-ray emission to mainly pass through beryllium. Another material that may be used to construct the anode and/or the cathode is copper: however, the high x-ray emission will erode the copper anode quickly. In addition, the cathode and/or the anode may be made partially from metals (e.g. Aluminum, Copper, aluminum, beryllium, chromium, copper, gold, nickel, molybdenum, palladium, platinum, silver, tantalum, titanium, tungsten and zinc) and alloys (e.g. copper-alloy, beryllium-alloy, copper-beryllium-alloy, Aluminum-alloy and other metal alloy), The cathode and/or the anode may also include a variety of dopants, e.g. beryllium, tungsten, molybdenum, rhenium , etc.

The insulator that separated the anode and the cathode may be made from a variety of materials depending on the particular application. For example, the insulator material may be made at least partially from quartz, pyrex glass, lava rock , ceramic, ceramic oxide and nitrides of aluminum, beryllium, boron, calcium, silicon, sodium and zirconium, boron carbide and combination thereof. In addition, insulators may be machined, formed or shaped by conventional processes to the desired size, shape, thickness and profile. Other insulation material such as ceramic, ceramic oxides and nitrides made from aluminum, beryllium, boron, calcium , silicon and zirconium, e.g. Alumina (Al₂O₃), Silicon Nitride (Si₃N₄), Aluminum Nitride, Beryllium Oxide (BeO), Boron, Carbide (B₄C), Zirconia (ZrO₂) and combination thereof, may also be used for. Selection of the insulator material will depend upon the size, and current range of the device.

The Present invention includes a method for conversion of charged particles, X-rays and heat into electricity by transmutation of target elements H, D, Li, B or any other elements of the periodic table (e.g., from H to U and TRU) or its compounds , salts containing one or more elements of the periodic table.

The target elements can be one or more elements of periodic table , preferably H/D/Li/B in gaseous form, liquid or molten state.

The reaction chamber having vacuum vessel, one or more connections to allow the induction and/or removal of one or more gases into the reaction chamber. The reaction chamber is positioned so that there is communication between the reaction chamber where energy released and a particle capturing device. The shape and dimension of the particular reaction chamber will depend on the size of the volume of target elements, volume of the chamber and so forth.

The method for converting energy in the form of charged particles, X-rays and heat into electrical energy includes generation one or more particles made of one or more charged particles, one or more X-rays or combination thereof. The particle capturing device is used to recover the one or more particles and includes charged particles energy recovery circuit and X-rays energy converter that may be incorporated into one device or separate devices depending on the needs of the particular application.

The X-ray energy converter includes one or more capacitors in electrical communication with one or more electron emitter layers and one or more electron collector layers. The one or more electron emitter layers adsorb the x-ray and emit electrons that are then adsorbed by the one or more electron collector layers. The X-ray energy converter may be a series of one or more x-ray energy converter positions to collect x-rays of different energy level. For example, the one or more x-ray energy converter may be one or more electron emitter layer and one or more electron collector layers nested concentrically to collect x-rays of different energy levels. Similarly, one or more electron collector layers positioned to absorb emissions of different energy and one or more electron emitter layers may be a series of one or more electron emitter layers. Generally, each of the one or more electron collector layers are separated by a voltage of between about 15 and about 25% relative to the next electron collector layer; however the electron collector layers may be separated by a voltage of between about 10 and about 30% relative to the next electron collector layer depending on the particular application.

The method converting energy from transmutation of target elements into electrical energy includes a nested electrode design having a hollow cylinder anode centrally positioned among one or more cathodes positions to impart angular momentum. The one or more helical cathodes are positioned at a helical angle with the angle depending on the particular application, but generally about 0.3 degrees, but may range between about 0.05 and about 10 degrees.

The anode has an anode radius and the cathode has a cathode radius that imparts a high magnetic field. The anode radius is between about 0.25 and 1.5 cm times the peak current measured in mega-amperes in the device and the cathode radius is between about 0.5 cm and about 3 cm times the peak current measured in mega-amperes in the device.

The present invention also includes an apparatus for transmutation of elements for production of energy and converting that energy into electrical energy that includes a reaction chamber, energy conversion devices, switches and energy storage devices, and a cooling system. The reaction chamber includes heating arrangements, crucible to hold target elements in the form of molten, liquid, solid, gaseous or in combination thereof.

The present invention also includes energy conversion system of charged particles, X-rays and heat into electrical energy. X-ray energy converter for directly converting X-ray emission into electrical energy having one or more capacitors in electrical communication with one or more electron emitter layers and one or more electron collector layers. The one or more electron emitter layers adsorb the X-ray and emit electrons that are then adsorb by one or more electron collector layers.

The X-ray energy converter may be a series of one or more X-ray energy converter positioned to collect x-rays of different energy levels. For example, the one or more X-ray energy converter may be one or more electron emitter layers and one or more electron collector layers nested concentrically to collect x-rays of different energy levels . Similarly, one or more electron collector layers may be a series of one or more electron collector layers positioned to adsorb emissions of different energy and one or more electron layers. Generally, each of the one or more electron collector layers are separated by a voltage of between about 15 and about 25% relative to the next electron collector layer; however the electron collector layers may be separated by a voltage of between about 10 and about 30% relative to the next electron collector layer depending on the particular application.

For high efficiency in converting the energy of the x-rays into the energy of the electrons, the converter design must ensure that nearly all the X-rays are absorbed in films A and that very little of the electrons energy is adsorbed before they leave film A. This means that for electrons (and thus X-rays) of a given energy E the thickness of each film A must be small (e.g. from about 1 to about 10% and ideally less than about 5%) of the stopping distance in material A of electrons of that energy. At the same time the total thickness of all layers A must be at least 3 times the attenuation distance of X-rays of energy E in material A. In addition , X-ray absorbance in films B must be minimized by suitable choice of material .

In practice, conversion efficiency can only be optimized for a range in X-ray energy considerably narrower than the range actually emitted from the transmutation process, so a series of collectors, nested concentrically, must be designed, with the collectors for lower energy X-rays closet to the transmutation apparatus and those for higher energies further away. Additionally, the total capacitance of all layers for each X-ray energy range must be sufficient to capture the full energy emitted within that range.

The efficiency of conversion of the electrons energy into stored electric energy is determined by the number of type B films per layer. If the voltages of the type B films are set so that each is 20% higher than its next lower neighbor, with the minimum voltage being slightly above the maximum x-ray energy and the maximum slightly above the maximum X-ray energy and the maximum slightly above the maximum x-ray nervy for a given range, the average conversion efficiency will be about 80%. On the other hand, the B films cannot be set so close together that the field between them exceeds the dielectric breakdown of the insulators that separate and physically support each film.

In general, the collectors optimized for lower energies will have relatively light type A material, for example aluminum, so as not to require excessively thin films, with copper will be used for intermediate energies and heavier metals such as tungsten for highest energies. In most cases, type B materials will be light metals to minimized x-ray absorption, e.g., aluminum and beryllium.

For example, a collector optimized for a 10 KJ, 3 ns long pulse of x-rays , with a distribution of energies from about 10 KeV to 80 KeV, with about half the energy below 20 KeV. There are 7 type B films for each type A films with the X-ray converterr having three optimized converters with the parameters describer in the table. In this example, about 95% of electron energy escapes the type A films and about 90% of escaped electron energy is stored as electrical energy, for an overall about 80% conversion efficiency of x-ray energy into stored electrical energy.

The Type B electrodes at a give potential are connected to each other through appropriately spaced and insulated conductors that parallel the cooling system, described below, while type A electrodes are similarly connected together to ground.

Energy conversion of charged particles. Existing art can be used to efficiently collect energy from the charged particles . Either peniotron converters (e.g., Yoshikawa et al) or Gyrotron can be used to couple the charged particles efficiently to a RF pulse. A series of fast switches (e.g., diamond switches) activated by UV light , can be used to couple the RF pulse into fast storage capacitors, with the switch opening when the capacitors are charged, preventing energy from flowing back into the resonator. The charged particles spread in flight, but still has a short pulse length of about 30 ns when it arrives at the converter creating a rapidly varying magnetic field, make it easier to optimize an efficient design to couple the energy into a circuit. However, the high power (e.g., about 500 GW) requires careful design of the circuit to link the transfer the power into capacitors at reasonable potentials.

Overall operation and circuitry of reactor: The reactor operated in three phases for each pulse. In the first phase, one or more target elements are transmuted using existing process (Suneel N Parekh PCT Publication WO 2016/181204 A1), In the second phase, energy released from transmutation process, e.g. in the form of charged particles, x-rays and heat is converted to electricity and stored in capacitors. Subsequently energy is stored in multiple capacitor banks. In the third phase , electric energy can be output as a steady DC current to the grid, or converted to AC current. The circuit is indicated schematically here and the details of the switching systems are clear to one skilled in the art.

Cooing system: Generally, the cooling system removes heat from the reactor, the x-ray conversion system and the charged particles conversion system. The anode is the most demanding, as it is the smallest. For example, an anode with a radium of about 1.4 cm and length of about 4 cm, the anode has a surface area of about 35 cm2. A beryllium anode will absorb through internal resistance about 100 J for each pulse of about 2.8 MA and about 0.5 microseconds. Since the maximum hear removal rate is generally considered to be around 2.5 KW/cm2, a pulse rate of about 1 kHz is about the maximum that can be used for a single electrode. Since this is far less than the 500 kHz cycle time of the main capacitors, several electrode set could be run from a single bank of capacitors. For example, about 5 MW of net output could then be expected for each electrode set.

Since the charged particles energy conversion system has a large surface area and the residual heat is distributed within it, cooling it is relatively routine to the skilled artisan. In the case of the X-ray conversion system, however, care must be taken to avoid blocking the X-rays or electrons with the coolant itself by passing an electrically non-conducting coolant , such as silicon, through several dozen very narrow pair of plates, all oriented radially toward the transmutation reactor. If the coolant plates have a typical separation of a few tens of microns , they absorb less than about 1% radiation, but are still able to carry adequate coolant flow to remove about 2 MW of waste heat from the X-ray conversion device. The coolant plats, running radially through the device every several degrees can also serve to give mechanical support to the thin film electrodes.

It will be understood that particular embodiments described herein are shown by way of illustration and not as limitation of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the composition and/or methods disclosed and claimed herein can be made and executed without undue experimentation in light of the present disclosure. While the compositions, devices, apparatus, system and method of this invention have been describe in terms of preferred embodiments, it will be apparent to those of skill in the art that variations can be applied to the compositions, devices, systems, apparatus and/or methods and in the steps or in the sequence of steps of the methods described herein without departing from the concept, spirit and scope of the Invention. All such similar substitute and modifications apparent to those skilled in the art deemed to be within the spirit, scope and concept of the invention as defined by the appended claims.

As illustrated in the figures, a Electric Power Generation system of the present invention preferably includes a transmutation reactor coupled to a direct energy conversion system. As alluded to above, the present transmutation reactor solves the problem associated with thermonuclear fusion reactor.

In a direct energy conversion process of the present invention, the charged particles released during transmutation of target element can be slowed down and their kinetic energy converted directly to electricity. Advantageously, the direct energy conversion system of the present invention has the efficiencies, particle-energy tolerances and electronic ability to convert the frequency and phase of the fusion output power of about to match the frequency and phase of an external 50/60 Hertz power grid.

Some exemplary reactions which may be feasible with the present invention proceed as follows. First, H, D and B can be made to yield transmutation according to the basis of Einstein's principle of mass-energy equivalence, this mass corresponds to a rest energy of 9×10¹⁶ j/kg

Mass is converted into energy E=mc², e.g. with m=1 kg and c=3×10³ m/sec: E=(1×(3×10⁸)²=9×10¹³ j/g

Paramagnetic and excited mercury-based compound is used as a source of energy fabricated by any method including of prior art PCT Publication number WO 2016/181204 A1 in the apparatus for transmutation of elements and generating energy.

Electricity production device of the present invention can be from kilowatts to Gigawatts, but not limited to it. It will be grid and off grid for all kinds of electricity applications such as for Residentials, Commercials, Industrials, Agricultures, Desalination of water, Office, Sport complex, Entertainment, Medical Hospitals, Engineering, Transportation, Communication, Outdoors, Spacecraft, Rockets, fuel and so on.

Using Mercury-based Compound, which is present in the excited state and is paramagnetic, target elements can be transmuted into many new elements in the range of 1% to 100% , depends on the target material (Endothermic and Exothermic reaction). The technology will transmute lighter target elements such as H, D, Li, B, Al and heavier elements such as fissile Actinides, non fissiles actinides and transuranic elements into many new elements and releases energy many times of fusion reaction.

In the fusion of two hydrogen nuclei to form helium, 0.7% of the mass is carried away from the system in the form of kinetic energy or other form of energy (such as Electromagnetic radiation). Whereas using mercury-based compound, which is paramagnetic and present in the excited state (PCT Publication number: WO 2016/181204 A1), conversion of mass into energy is many times than fusion of two hydrogen nuclei.

Transmutation process converts the target elements into many new elements and results in the removal of energy when nucleus is formed, and this energy has mass, mass is removed from the nucleus. This missing mass is known as mass defects and represents the energy released when the nucleus is formed.

Transmuted product energies is directly converted into electric power without steam cycle. Preferably, during the transmutation process, there is energy released in the form of Charged particles, X-rays and heat. Released Energy from transmutation process is captured and converted into electricity.

Advantageously, the energy conversion system include target elements, paramagnetic and excited state mercury-based compound as a source of energy, which reacts with nucleus of the target elements and releases energy in the form of Charged particle, X-rays and heat. Direct energy pickup from the transmutation of elements and generation of electricity.

The present invention for direct conversion of mass into energy will be more energetic per unit of mass than nuclear fusion.

Target elements such as heavier elements including of long-lived radioactive target elements can be transmuted into short-lived or stable elements and during the transmutation process there will be energy released in the form of charged particles, X-rays and heat , which will be used for production of electricity.

Energy released during transmutation will be used as a fuel for interplanetary or interstellar travel or rocket or spacecraft. Since the energy density of transmutation process is higher than that of conventional fuels, an transmutation-fueled spacecraft would have a higher thrust-to-weight ratio than a conventional spacecraft.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

Current rocket speed is 15 km/sec and using the present invention and subject matter of claims, the rocket speed can be many times of current rocket technology.

The present invention will be source for high energy density and cheap source of energy, i.e. 90 MJ/ug.

Energy from gamma rays can be converted into charged particle. Magnetic field are very good for directing charged particles for production of electricity.

The present invention will be used as a propellant mechanism for lower orbit Satellites, Earth Orbiting Satellites.

Over thousands of Satellites to be deployed for purposes of earth energy, broadband, and other applications.

Fusion of two hydrogen nuclei emits 0.7% of kinetic energy or electromagnetic radiation, whereas transmutation technology based on paramagnetic and excited state mercury compound will react with nucleus of target elements and it will converts 10 to 100% of mass into energy based on target material.

The present invention will allow space vehicle to attain 50% or more of speed of light.

One gram of matter will produce 180 Terajoules. This would make very cost-effective as a rocket fuel to send a probe to Pluto and back in a year, a mission that would be completely unaffordable with conventional fuels.

The 1 kg of paramagnetic and excited state mercury based compound would produce 9×10¹⁶ j or 9×10¹³ j/g (hundreds of terajoules/g) of energy (by the mass-energy equivalence formula, E=mc²).

Transmutation pulse propulsion, power generation, rocket, fuel will just need few grams of paramagnetic and excited state mercury based compound with target elements such as hydrogen or fissionable element to allow a one-way transit time to Mars of 30 days. This reaction releases a tremendous amount of energy, of which some is released as gamma rays and some is transferred as kinetic energy.

Rocket efficiency is strongly related to the mass of the working mass used, which in this case is the nuclear fuel. The energy released by a given mass of transmutation fuel is several times larger than that released by the same mass of a fission or fusion fuel.

For missions requiring short periods of high thrust, such as manned interplanetary missions, the present invention will be preferred because it reduces the number of fuel elements needed.

For missions with longer periods of higher efficiency but with lower thrust, such as outer-planet probes, a combination of one or more elements of periodic table target will be preferred because it would reduce the total fuel mass.

Using the present invention, the production of electricity can be used as a fuel for interplanetary or interstellar travel as part of a transmutation catalyzed nuclear pulse propulsion or other rocketry, such as the space vehicle. Since the energy density of transmutation energy is higher than that of conventional fuels, an transmutation-fueled spacecraft would have a higher thrust-to-weight ratio than a conventional spacecraft.

The present invention is the only conceivable source of energy for rapid, efficient, rocket space travel to Mars, the outer planets, and nearby stars, if the payloads are heavy and/or designed to carry humans.

The Electricity production devices can be easily set up for generation of electricity of onsite, off grid for all kind of electricity application, thus reducing losses of electricity thru Grid supply and not dependent of grid infrastructure.

Electricity production device of the present invention can be from kilowatts to Gigawatts, but not limited to it. It will be grid and off grid for all kinds of electricity applications such as for Residentials, Commercials, Industrials, Agricultures, Desalination of water, Office, Sport complex, Entertainment, Medical Hospitals, Engineering, Transportation, Communication, Outdoors, Spacecraft, Rockets, fuel and so on.

The invented transmutation technology releases fusion energy in the form of charged particles, X-rays and heat. There is no neutron released in the transmutation process. This is extremely important because:

Neutrons are destructive to material structures. If you do not have any neutrons, then all the problems associated with neutron radiation is completely eliminated such as ionizing damage, neutron activation, biological shielding, remote handling and safety.

Neutrons produce radioactivity by merging with other nuclei and generate unstable or radioactive materials. No neutrons , no radioactive wastes.

Advantages of the transmutation technology as follows, i.e.
1. Clean, Safe, Carbon free Sustainable, and Zero emission.
2. No greenhouse gases, No fuel spillage, No radioactive waste, No pollution
3. It doesn't emit harmful toxins like carbon dioxide or other greenhouse gases into the atmosphere.
4. It doesn't employ any fissile materials like uranium and plutonium. So no risk of chain reaction and no risk of meltdown.
5. Off Grid, Onsite power generation, and not dependent on any weather conditions,
6. Power on-demand using existing grid infrastructure
7. It is more economical and needs less land than other renewable technologies.

Invented transmutation technology got potential to provide a sustainable solution to nation's energy need and its economic growth with complete respect to the environment and our population.

Mass is converted into energy E=mc2

The energy per unit mass (9*10¹⁶ J/ kg)

The energy per unit mass (9*10¹³ J/g)

The present invention is the only direct conversion of mass into energy is more energetic per unit of mass than nuclear fusion.

Paramagnetic and excited state mercury based compound having very large internal resting energy, which is employed as a source of energy. When the compound comes into contact with target elements, resting energy of compound converts into kinetic energy and reacts with the nucleus of the target elements, and transmutes target elements into many new elements and generates energy.

If matter-antimatter collisions resulted only in photon emission, the entire rest mass of the particles would be converted to kinetic energy. The energy per unit mass (9*10¹⁶ J/kg) by the mass-energy equivalence formula E=mc2.

Annihilation requires and converts exactly equal masses of antimatter and matter by the collision which releases the entire mass-energy of both, which for 1 gram is =9×10 ¹³ joules.

Antimatter is a solution to energy problem, but a major obstacle is the cost of producing antimatter even in small quantities. As of 2004, the cost of producing one millionth of a gram of antimatter was estimated in USD billions.

In reality, however, most known technologies for producing antimatter involve particle accelerators and they are currently still highly inefficient and expensive. The production rate per year is only 1 to 10 nanograms. In 2008, the annual production of antiproton at the Antiproton Decelerator facility of CERN was several picograms at a cost in USD millions.

As the antimatter must remain away from ordinary matter until the desired moment of the explosion. The current (2011) record for antimatter storage is just over 1000 seconds performed in the CERN facility, a monumental leap from the millisecond timescales that previously were achievable.

Antimatter Catalyzed Micro-Fission (ACMF) engine as its main form of propulsion. The spacecraft was designed at Penn State University in the 1990s as a way to accomplish a manned mission to Mars. The proposed ACMF engine would require only 140 Nano grams of antiprotons in conjunction with traditional fissionable fuel sources to allow a one-way transit time to Mars of 30 days. This is a considerable improvement over many other forms of propulsion that can be used for interplanetary missions, due to the high thrust-to-weight ratio and specific impulse of nuclear fuels. Some downsides to the design include the radiation hazards inherent to nuclear pulse propulsion as well as the limited availability of the antiprotons used to initialize the nuclear fission reaction.

An antimatter rocket is a proposed class of rockets that use antimatter as their power source. There are several designs that attempt to accomplish this goal. The advantage to this class of rocket is that a large fraction of the rest mass of a matter/antimatter mixture may be converted to energy, allowing antimatter rockets to have a far higher energy density and specific impulse than any other proposed class of rocket.

If matter—antimatter collisions resulted only in photon emission, the entire rest mass of the particles would be converted to kinetic energy. The energy per unit mass (9×10¹⁶ J/kg) is about 10 orders of magnitude greater than chemical energies, and about 3 orders of magnitude greater than the nuclear potential energy that can be liberated, today, using nuclear fission (about 200 MeV per fission reaction or 8×10¹³ J/kg), and about 2 orders of magnitude greater than the best possible results expected from fusion (about 6.3×10¹⁴ J/kg for the proton-proton chain). The reaction of 1 of antimatter with 1 kg of matter would produce 1.8×10¹⁷ J (180 petajoules) of energy (by the mass-energy equivalence formula, E=mc²).

There are extreme astrophysical events that can lead to short period of fusion with heavier nuclei. This is the process that gives rise to nucleosynthesis, the creation of the heavy elements during events such as supernovae.

On the basis of Einstein's principle of mass-energy equivalence, this mass corresponds to a rest energy of 9×10¹⁶ j/kg.

Mass is converted into energy E=mc², i.e. E=9×10¹⁶ j/kg.

So the energy equivalent of one kilogram of mass is
90 petajoules=9×10¹⁶ j/kg
25.0 billion kilowatt-hours 25,000 GW-h)
21.5 trillion kilocalories 21 Pcal)
85.2 trillion BTUs
0.0852 quads

For example, in the fusion of two hydrogen nuclei to form helium, 0.7% of the mass is carried away from the system in the form of kinetic energy or other forms of energy (such as Electromagnetic radiation).

E=(m2−cm1)c², with e.g. m1=0.993×10⁻³ kg and m2=1×10⁻³ kg, c=3×10⁸ m/s, results in E=(1×10⁻³−0.993×10³) (3×10⁸)²=6.3×10¹¹ j

So 6.3×10¹¹ j energy is released when 1 gm of hydrogen is converted into 0.993 gm of helium in a thermonuclear reaction.

1 gm of Hydrogen will produce energy 6.3*10¹¹ Joules

1 kg of Hydrogen will produce energy 6.3*10¹⁴ joules

The energy per unit mass (9*10 ¹⁶ J/kg).

Four hydrogen nuclei have a total mass of 6.693*10²⁷ kg. They fuse into a helium nucleus of mass 6.645*10²⁷ kg. The mass lost is 0.048*10²⁷ kg. Thus only the fraction, 0.048/6.693=0.00717 of the original hydrogen mass was converted into energy. In other words, when you start with 1 kg of hydrogen, a mass of 0.00717 kg will be converted into energy during fusion. This gives an energy output of

E=mc²=0.00717*(3.0*10⁸)²=6.45 *10¹⁴ joules/kg

It is still a huge amount of energy, even though most of the kilogram is still there afterwards (now in the form of helium).

If mass of 1 kg of Hydrogen is converted into 100% energy then E=9×10¹⁶ j energy will be released.

Similarly, the reaction of 1 kg of antimatter with 1 kg of matter would produce 2*9*10¹⁶ J of energy (by the mass-energy equivalence formula E=mc²)

The British thermal unit (Btu or BTU) is a non-SI, traditional unit of heat; it is defined as the amount of heat required to raise the temperature of one pound of water by one degree Fahrenheit. Heat is now known to be equivalent to energy, for which the SI unit is the Joule; one BTU is about 1055 joules.

When used as a unit of power for heating and cooling systems, Btu per hour (Btu/h) is the correct unit, though this is often abbreviated to just “Btu”.

1 watt is approximately 3.412142 Btu/h

1000 Btu/h is approximately 293.1 W

1(HP) horsepower is approximately 2,544 Btu/h

The fundamental reason for the “mass defects” is Albert Einstein's formula E =mc², expressing the equivalence of energy and mass. By this formula, adding energy also increases mass (both weight and inertia), whereas removing energy decreases mass. Energy of all types is seen in systems as mass, since mass and energy are equivalent and each is a “property” of the other.

Nuclear fusion of deuterium-tritium produces neutrons of 14.1 MeV (1400 TJ/ kg , i.e., 52000 km/ sec, 17.3% of the speed of light), That can easily fission U²³⁸ and other non-fissile actinides.

Two basic type of radiation exists; energetic particles and packets of energy called photons. Particle radiation included alpha particles, beta radiation, neutrinos, cosmic rays, and host of subatomic particles such as the muon. Radiant energy photons, also called electromagnetic waves, include radio waves, microwaves, infrared waves, visible light waves, ultraviolet waves, X-rays and Gamma rays.

Gamma rays are a form of electromagnetic radiation, as are visible lights, radio waves, infrared and X-rays. Unlike alpha and beta particles, gamma rays have no mass and no electric charge. When an unstable atom gives off gamma radiation, the element remains the same. Gamma decay just changes the energy level of the nucleus.

Possibly matter is almost completely converted into energy in the cores of neutron stars and “black holes” by a process of nuclei collapse resulting in: proton→positron+938 MeV, resulting in a >450 MeV positron-electron jet. Trace nuclei swept up in such a beam would achieve an approximate energy of (nucleus mass/electron mass)×450 MeV, for example an iron atom could achieve about 45 TeV. An up to 45 TeV atom impacting a proton in the interstellar medium should result in the p+A process described above.

The extreme astrophysical event of a supernova can produce enough energy to fuse nuclei into elements heavier than iron. An important fusion process is the stellar nucleosynthesis that powers Stars and the Sun. In the 20th century, it was recognized that the energy released from nuclear fusion reactions accounted for the longevity of stellar heat and light

The D-T fusion reaction has a positive Q-value of 2.8×10⁻¹² joule. The H-H fusion reaction is also exoergic, with a Q-value of 6.7×10⁻¹⁴ joule. To develop a sense for these figures, one might consider that one metric ton (1,000 kg, or almost 2,205 pounds) of deuterium would contain roughly 3×10³² atoms. If one ton of deuterium were to be consumed through the fusion reaction with tritium, the energy released would be 8.4×10²⁰ joules. This can be compared with the energy content of one ton of coal—namely, 2.9×10¹⁰ joules. In other words, one ton of deuterium has the energy equivalent of approximately 29 billion tons of coal.

In chemistry, the term proton refers to the hydrogen ion, H. Since the atomic number of hydrogen is 1, a hydrogen ion has no electrons and corresponds to a bare nucleus, consisting of a proton (and 0 neutrons for the most abundant isotope protium 1 H1). The proton is a “bare charge” with only about 1/64000 of the radius of a hydrogen atom, and so is extremely reactive chemically.

Mass of proton=1.007825 a.m.u

Mass of neutron=1.008665 a.m.u

Transmutation/Nuclear reaction change the atomic nuclei and thus the identities of nuclide. They are accomplished by bombardment using subatomic particles or photons or atomic nuclei. Sub atomic particles are used to bombard or emitted in nuclear reactions;

g photons, b electrons, p or ¹H protons, n neutrons, d or ²D deuterons, t or ³T tritons, a or ⁴He alpha particles, ⁿE atomic nuclei, Energy Particles.

Nuclear binding energy is the energy required to split a nucleus of an atom into its component parts. The component parts are neutrons and protons, which are collectively called nucleons. The binding energy of nuclei is always a positive number, since all nuclei require net energy to separate them into individual protons and neutrons. Thus, the mass of an atom's nucleus is always less than the sum of the individual masses of the constituent protons and neutrons when separated. This notable difference is a measure of the nuclear binding energy, which is a results of forces that hold the nucleus together. Because these forces results in the removal of energy when the nucleus is formed, and this energy has mass, mass is removed from the total mass of the original particles, and the mass is missing is the resulting nucleus. This missing mass is known as the mass defect and represents the energy released when the nucleus is formed.

An absorption or release of nuclear energy occurs in nuclear reaction or radioactive decay, those that absorb energy are called endothermic reactions and those that release energy are exothermic reactions. Energy is consumed or liberated because of differences in the nuclear binding energy between the incoming and outgoing products of the nuclear transmutation.

In any exothermic nuclear process, nuclear mass will ultimately be converted into thermal energy, given off as heat, carries away mass with it. In order to quantify the energy released or absorbed in any nuclear transmutation, one must know the nuclear binding energy of the nuclear components involved in the transmutation.

The fundamental reason for the “mass defects” is Albert Einstein's formula E=mc2, expressing the equivalence of energy and mass. By this formula, adding energy also increases mass (both weight and inertia), whereas removing energy decreases mass. Energy of all types is seen in systems as mass, since mass and energy are equivalent and each is a “property” of the other.

Energy is consumed or liberated because of differences in the nuclear binding energy between the incoming and outgoing products of the nuclear transmutation. For endothermic reactions, the energy can be supplied in the form of kinetic energy of the incident particle.

Energy appears as kinetic energy of the products in exothermic reactions.

Examples illustrate exothermic reaction, i.e.

¹¹B+4H @ n+¹⁴N+Q

11.00931+4.00260=1.0086649+14.00307+Q

Q=11.00931+4.00260−(1.0086649+14.00307)=0.0001751 amu

Q=0.163 MeV (Exothermic)

The unit in which atomic and nuclear masses are measures is called atomic mass unit (a.m.u.). Hence change in mass of lamu (called mass defect) releases an energy equal to 931.25 MeV. 1 a.m.u=931.25 MeV is used as standard conversion.

Binding energy per nucleon

Mass of Proton/1H=1.007825

Mass of Neutron/n=1.008665

For example Hydrogen (H)

1*m(¹H) 1.007825+0*n 1.008665=1.007825

Total mass 1.007825−Mass of Hydrogen 1.007825=0 MeV

Nucleus of hydrogen has only one proton. Hence its binding energy will be zero. The nuclear binding energy is the energy it takes to separate all the nucleons in a nucleus from each other. Since there is only the one nucleon, it's already separated from any other nucleons.

For example Deuterium (²D)

1*m (¹H) 1.007825+1*m(n) 1.008665=2.025155

Total mass 2.025155−of Deuterium 2.014101=0.011054 a.m.u

0.011504*931.25 MeV=10.2940375/2=5.147018 MeV BE/Nucleon

For example Iron (⁵⁶Fe)

26*m (¹H) 1.007825=26.20345

30*m (n) 1.008665=30.25995

Total mass of 56.4634−Mass of ⁵⁶Fe 55.9349=0.5285*931.25=492.165625

So the Binding Energy Per Nucleon=492.165625/56=8.78 MeV

Iron nuclei are the most stable nuclei (in particular Iron 56), and the best source of energy is therefore nuclei whose weight is as far removed from iron as possible. One can combine the lightest one—nuclei of hydrogen (protons) to form nuclei of helium, and that is how Sun generates it energy. Or else one can break up the heaviest ones—nuclei of uranium into smaller fragments, and that is what nuclear power reactors do.

Energy cannot be created nor be destroyed but it can be converted from one form to another. Nearly all the mass of the atom is concentrated in a tiny nucleus in the centre. The nucleus is composed principally of two sorts of particles: the proton, which carries the positive charge, and neutron, which is electrically neutral and has a mass slightly bigger than that of proton.

Nuclear energy is the energy released from the nucleas of an atom. When nuclear reaction occurs, it produces large amount of energy. Changes can occur in the structure of the nuclei of atoms. These changes are called nuclear reactions. Energy created in a nuclear reaction is called nuclear energy, or atomic energy.

Nuclear energy is a powerful source of energy, generated during a nuclear reaction, by change in the nucleus of an atom. The source of nuclear energy is the mass of nucleus and energy generated during a nuclear reaction is due to conversion of mass into energy (mass defects).

When fission occurred, not only were two lighter elements and lots of radiation produced, but also more neutrons. It was clear that these neutrons could in turn also cause fission, producing more neutrons and developing a chain reaction. When Fusion occurred hydrocarbons and many new elements produces including of low mass, high mass, high density, rare earth and Super heavy elements.

The fusion of two nuclei with lower masses that iron (which, along with nickel, has the largest binding energy per nucleon) generally releases energy, while fusion of nuclei heavier than iron absorbs energy. All nuclear fusion reactions that produce heavier elements cause the star to lose energy or are said to be endothermic reactions.

Production of elements from iron to uranium occurs within seconds in a supernova explosion. Due to the large amounts of energy released, much higher temperatures and densities are reached than at normal stellar temperatures. These conditions allow for an environment where transuranic elements will be formed.

The nucleus of an atom is composed of protons and neutrons, which are in turn composed of fundamental particles known as quarks. Each element has a characteristic number of protons but may take a variety of forms, or isotopes, each with a different number of neutrons. Elements can decay into other ones if the process results in a lower energy state. Gamma radiation is a decay emission of pure energy.

The laws of quantum physics predict that an unstable atom will lose energy through decay but cannot forecast precisely when a particular atom will undergo this process. The most that quantum physics can predict is the average amount of time a collection of particles will take to decay. The first three types of nuclear decay discovered were dubbed radioactive decay and consist of the alpha, beta and gamma decay. Alpha and beta decay transmute one element into another and are often accompanied by gamma decay, which releases excess energy from the decay products.

Gamma decay is a typical byproduct of nuclear PARTICLE EMISSION. In alpha decay, an unstable atom emits a helium nucleus consisting of two protons and two neutrons. For example, one isotope of uranium has 92 protons and 146 neutrons. It can undergo alpha decay, becoming the element thorium and consisting of 90 protons and 144 neutrons. Beta decay occurs when a neutron becomes a proton, emitting an electron and antineutrino in the process. For example, beta decay turns a carbon isotope with six protons and eight neutrons into nitrogen containing seven protons and seven neutrons.

Gamma decay is a typical by product of nuclear PARTICLE EMISSION Particle emission often leaves the resulting atom in an excited state. Nature, however, prefers that particles assume the state of least energy, or ground state. To this end, an excited state nucleus can emit a gamma ray that carries away the excess energy as electromagnetic radiation. An example of gamma ray emission occurs when cobalt undergoes beta decay to become nickel. The excited nickel gives off two gamma rays in order to drop down to its ground state energy.

It usually takes very little time for an excited state nucleus to emit a gamma ray. However certain excited state nuclei are “metastable”, meaning they delay gamma ray emission. The delay may last only for a portion of a second but could stretch out over minutes, hours, years or even longer. The delay occurs when the spin of the nucleus prohibits gamma decay. Another special effect occurs when an orbiting electron absorbs emitted gamma rays and is ejected from orbit. This is known as the photoelectric effect.

Two basic type of radiation exists; energetic particles and packets of energy called photons. Particle radiation included alpha particles, beta radiation, neutrinos, cosmic rays, and host of subatomic particles such as the muon. Radiant energy photons, also called electromagnetic waves, include radio waves, microwaves, infrared waves, visible light waves, ultraviolet waves, X-rays and Gamma rays. Primary cosmic rays, which consist mostly of protons, cannot penetrate the earth's atmosphere. However, when primary cosmic rays interact with atmospheric particles, they produce penetrating secondary cosmic rays, especially muons. Muons penetrate the denser portions of the earth's atmosphere, reach the surface and even penetrate ocean waters to a considerable depth.

Alpha particles given off by radioactive minerals become pockets of helium gas. Elements that emit alpha radiation include uranium and polonium. Alphas have a +2 charge due to they having two protons. Nucleus emits helium nucleus (called alpha particles) and gets converted to another nucleus with atomic number lesser by 2 and atomic weight lesser by 4.

As with alpha particles, beta radiation comes from the nucleus of an unstable atom. Betas are electrons and their mass is much smaller than that of alpha particles−about 1/8000th as much. Betas have a charge of −1. Beta decay could be of two types; either through emission of an electron or positron (the antiparticle of electron). Electron emission causes an increase in the atomic number by 1, while the positron emission causes decreases in the atomic number by 1. In some cases, double beta decay may occur, emission of two beta particles.

Gamma rays are a form of electromagnetic radiation, as are visible lights, radio waves, infrared and X-rays. Unlike alpha and beta particles, gamma rays have no mass and no electric charge. When an unstable atom gives off gamma radiation, the element remains the same. Gamma decay just changes the energy level of the nucleus.

Electron capture is one of the most rarest decay modes. In this phenomenon, an electron is captured or absorbed by a proton rich nucleus. This leads to the conversion of a proton into a neutron in the nucleus, along with release of an electron neutrino. This leads to a decrease in atomic number (transmuting the element in the process), while leaving the atomic mass number unchanged.

Half-Life is the amount of time required, for half quantity of radioactive element to decay. For example ¹⁴C has a half-life of 5730 years. That is, if you take 1 g of ¹⁴C, then half of it will have been decayed in 5730 years.

The nuclear force (or nucleon—nucleon interaction or residual strong force) is a force that acts between the protons and neutrons of atoms. Neutrons and protons, both nucleons, are affected by the nuclear force almost identically. Since protons have charge +1, they experience an electric force that tends to push them apart, but at short range the attractive nuclear force is strong enough to overcome the electromagnetic force. The nuclear force binds nucleons into atomic nuclei.

The nuclear force is powerfully attractive between nucleons at distances of about 1 femtometre (fm, or 1.0×10⁻¹⁵ metres), but it rapidly decreases to insignificance at distances beyond about 2.5 fm. At distances less than 0.7 fm, the nuclear force becomes repulsive. This repulsive component is responsible for the physical size of nuclei, since the nucleons can come no closer than the force allows. By comparison, the size of an atom, measured in angstroms (A, or 1.0×10⁻¹⁰ m), is five orders of magnitude larger. The nuclear force is not simple, however, since it depends on the nucleon spins, has a tensor component, and may depend on the relative momentum of the nucleons.

The nuclear force plays an essential role in storing energy that is used in nuclear power and nuclear weapons. Work (Energy) is required to bring charged protons together against their electric repulsion. This energy is stored when the protons and neutrons are bound together by the nuclear force to form a nucleus. The mass of a nucleus is less than the sum total of the individual masses of the protons and neutrons. The difference in masses is known as the mass defect, which can be expressed as an energy equivalent. Energy is released when a heavy nucleus breaks apart into two or more lighter nuclei. This energy is the electromagnetic potential energy that is released when the nuclear force no longer holds the charged nuclear fragments together.

The nuclear force is a residual effect of the more fundamental strong force, or strong interaction. The strong interaction is the attractive force that binds the elementary particles called quarks together to form the nucleons (protons and neutrons) themselves. This more powerful force, one of the fundamental forces of nature, is mediated by particles called gluons. Gluons hold quarks together through color charge which is analogous to electric charge, but far stronger. Quarks, gluons, and their dynamics are mostly confined within nucleons, but residual influences extend slightly beyond nucleon boundaries to give rise to the nuclear force.

The nuclear forces arising between nucleons are analogous to the forces in chemistry between neutral atoms or molecules called London forces. Such forces between atoms are much weaker than the attractive electrical forces that hold the atoms themselves together (i.e., that bind electrons to the nucleus), and their range between atoms is shorter, because they arise from small separation of charges inside the neutral atom. Similarly, even though nucleons are made of quarks in combinations which cancel most gluon forces (they are “color neutral”), some combinations of quarks and gluons nevertheless leak away from nucleons, in the form of short-range nuclear force fields that extend from one nucleon to another nearby nucleon. These nuclear forces are very weak compared to direct gluon forces (“color forces” or strong forces) inside nucleons, and the nuclear forces extend only over a few nuclear diameters, falling exponentially with distance. Nevertheless, they are strong enough to bind neutrons and protons over short distances and overcome the electrical repulsion between protons in the nucleus.

Nuclear fusion is a reaction in which two or more atomic nuclei are combined to form one or more different atomic nuclei and subatomic particles (neutrons or protons). The difference in mass between the reactants and products is manifested as either the release or absorption of energy. This difference in mass arises due to the difference in atomic “ binding energy” between the atomic nuclei before and after the reaction. Fusion is the process that powers active or “ main sequence” stars, or other high magnitude stars.

A fusion process that produces nuclei lighter than iron-56 or nickel-62 will generally release energy. These elements have relatively small mass per nucleon and large binding energy per nucleon. Fusion nuclei lighter than these releases energy (an exothermic process), while fusion of heavier nuclei results in energy retained by the product nucleons, and the resulting reaction is endothermic. The opposite is true for the reverse process, nuclear fission. This means that the lighter elements, such as hydrogen and helium, are in general more fusible; while the heavier elements, such as uranium, thorium and plutonim are more fissionable. The extreme astrophysical event of a supernova can produce enough energy to fuse nuclei into elements heavier than iron.

The energy obtained from each kg of fuel is very high (ten million times higher than from fossil fuels) so the fuel costs are a very small part of the expected costs. Using present costs, the fuel would contribute much less than 1% to the cost of electricity.

Transmutation of elements releases tremendous amounts of energy in the form of a, b, y, X-rays, EM, n, heat and so on. This energy is catured for production of electricity.

Thus, it is desirable to provide a methods, apparatus, device and system for production of electric power by capturing of energy released from conversion of one chemical element into another element/s by transmutation , using any one or more target elements of the periodic table, and converting this released energy into electricity to meet demand supply gap of electricity and for improving quality of life for masses.

Methods, apparatus, device and system for production of electric power that tends to substantially reduce cost of energy that converts the energy of transmutation products to electricity with high efficiency.

Without limiting the scope of Invention, its background is described mainly in connection with transmutation process. The increase in energy consumption and the disadvantages of hydrocarbon fuels has led to a search of alternate source of energy. One such source is transmutation of elements and generation of energy, which offers an almost limitless source of energy.

Generally a Transmutation Reactor includes target elements, such as lighter elements of periodic table such as H, D, T Li, B, and so on. The target elements present either in solid, liquid, gaseous or molten state. These target elements can be transmuted by paramagnetic and excited state mercury based compound to produce energy in the form of Charged particles, X rays and heat. The energy released during transmutation is nuclear energy , which is much larger than that for chemical reaction, because binding energy that holds nuclear together is far greater than the energy holds the electron to a nucleus. The released nuclear energy during transmutation process in captured and converted into electricity.

Despite the suggested advantages of aneutronic fusion, the vast majority of fusion research has gone towards D-T fusion because the technical challenges of hydrogen—boron (p-B11) fusion are so formidable. Hydrogen—boron fusion requires ion energies or temperatures almost ten times higher than those for D-T fusion. For any give densities of the reacting nuclei, the reaction rate for hydrogen-boron achieves its peak rate at around 600 KeV(6.6 billion degree Celsius or 6.6 gigakelvins), while D-T has a peak at around 66 KeV (765 million degrees Celsius).

The higher atomic charge, Z, of B11 greatly increases the X-ray emission rate, which is proportional to Z2,

Finally, conversion of energy to electricity from transmutation process in the form of Charged particles and X-rays must be performed with high efficiencies.

The kilowatt hour is a unit of energy equivalent to one kilowatt (1 kW) of power sustained for one hour.

One watt second is equal to one joule. One kilowatt-hour is 3.6 megajoules, which is the amount of energy converted if work is done at an average rate of one thousand watts for one hour.

In physics, electromagnetic radiation (EM radiation or EMR) refers to the waves (or their quanta, photons) of the electromagnetic field, propagating (radiating) through space, carrying electromagnetic radiant energy. It includes radio waves, microwaves, infrared, visible light, ultraviolet, X-rays and gamma rays.

Classically, electromagnetic radiation consists of electromagnetic waves, which are synchronized oscillations of electric and magnetic fields.

In a vacuum, electromagnetic waves travel at the speed of light, commonly denoted c.

In homogeneous, isotropic media, the oscillations of the two fields are perpendicular to each other and perpendicular to the direction of energy and wave propagation, forming a transverse wave. The wave front of electromagnetic waves emitted from a point source (such as a light bulb) is a sphere. The position of an electromagnetic wave within the electromagnetic spectrum can be characterized by either its frequency of oscillation or its wavelength. Electromagnetic waves of different frequency are called by different names since they have different sources and effects on matter.

Electromagnetic waves are emitted by electrically charged particles undergoing acceleration, and these waves can subsequently interact with other charged particles, exerting force on them.

EM waves carry energy, momentum, and angular momentum away from their source particle and can impart those quantities to matter with which they interact.

Electromagnetic radiation is associated with those EM waves that are free to propagate themselves (“radiate”) without the continuing influence of the moving charges that produced them, because they have achieved sufficient distance from those charges. Thus, EMR is sometimes referred to as the far field. In this language, the near field refers to EM fields near the charges and current that directly produced them, specifically electromagnetic induction and electrostatic induction phenomena.

In quantum mechanics, an alternate way of viewing EMR is that it consists of photons, uncharged elementary particles with zero rest mass which are the quanta of the electromagnetic force, responsible for all electromagnetic interactions. Quantum electrodynamics is the theory of how EMR interacts with matter on an atomic level. Quantum effects provide additional sources of EMR, such as the transition of electrons to lower energy levels in an atom and black-body radiation.

The energy of an individual photon is quantized and is greater for photons of higher frequency. This relationship is given by Planck's equation E=hv, where E is the energy per photon, v is the frequency of the photon, and h is Planck's constant. A single gamma ray photon, for example, might carry ˜100,000 times the energy of a single photon of visible light.

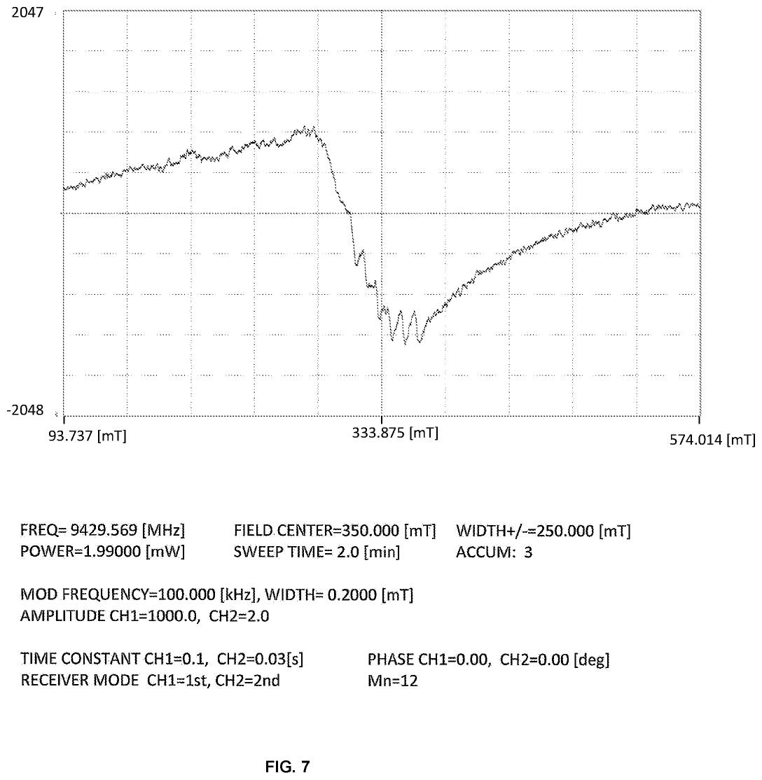

Electron Spin Resonance analysis were done at IIT Mumbai India to know the paramagnetic propertied containing unpaired electrons of mercury based compound. ESR analysis results show distinct peaks, which proves that fabricated mercury based compound is paramagnetic containing unpaired electrons (see FIG. 7).

For further verification of the present invention and its claims from third party, wherein paramagnetic and excited state mercury-based compound can transmute all elements of periodic table from Hydrogen to Uranium and transuranic elements, We have conducted two experiments at the Hot Cell Facility of Centrum Vyzukum Rez s r o (CVR) of Czech Republic, one of the leading nuclear research laboratory of Europe.

CVR arranged and procured all required material to perform the experiment such as pure liquid mercury metal, pure target elements Al, Pb, radionuclides target element such as Cs-137, mineral acids, beakers, Hot Plate, measuring device for verification of the paramagnetic and excited state mercury based compound capable of transmuting all elements of periodic table.

CVR measured background radiation of the Hot Cell facility before the experiment begin, which was found in the range of 40 nSv/ hr to 50 nSv/ hr.

During and after fabrication of the mercury based compound with aqua regia and nitric acid, there was radiation energy released in the form b, y/X rays, which was recorded 10000 nSv/hr. This increment of radiation compare to background radiation, during and after making of mercury-based compound proves that fabricated mercury based compound is present in the Excited State.

Fabricated mercury based compound was used to react with target elements Aluminum and Lead. During the process, there was radiation energy measured 10000 nSv/hr in the form of beta, gamma, y/X rays, this increment of radiation measured compare to background radiation of the Hot Cell Facility proves nuclear reactions took place as per subject matter of claim.

For the second experiment, CVR arranged High Purity Germanium detector to measure the activity of long-lived radionuclide target element Cs-137 before the experiment begin and recorded radiation as follows, i.e.

Cs¹³⁷ 2.359 MBq/second

Fabricated mercury based compound was used and reacted with radionuclide target element Cs-137.

After the completion of the process, again all resultant radionuclide target elements was measured for its activity using HPGe detector and recorded radioactivity as follows, i.e.

Cs¹³⁷ 0.359 MBq/second

HPGe analysis results proves that radioactivity of resultant target element was reduced over 80% after using fabricated mercury based compound with radionuclide target element. Transmutation of long-lived radioactive target element into stable or short-lived elements is the proof , that paramagnetic and excited state mercury compound having large internal resting energy and when it comes into contact with target elements (any one or more elements of the periodic table), the resting energy of compound converts into kinetic energy and reacts with nucleus of the target element. Transmute target elements into many new elements and release energy. The energy is many times of fusion energy.

Paramagnetic and excited state Mercury-based Compound is used as a source of energy (based on Prior art PCT Publication number: WO 2016/181204 A1) and reacted with target elements (any one or more elements of the periodic table), for transmutation of target elements and generation of energy, which will be converted into electricity.

Electricity production device of the present invention can be from kilowatts to Gigawatts, but not limited to it. It will be grid and off grid for all kinds of electricity applications such as for Residentials, Commercials, Industrials, Agricultures, Desalination of water, Office, Sport complexes, Entertainment, Medical Hospitals, Engineering, Transportation, Communication, Outdoors, Spacecraft, Rockets, fuel and so on.

The following text closely adheres to the wording of the priority application IN 2020 2102 6656 of Jun. 24, 2020).

The present invention relates to a method, an apparatus, a device and a system for the generation of electricity.

The present disclosure relates generally to the field of chemistry, physics, particle physics, engineering, electrical engineering, and, in particular, to methods, apparatus, device and system for production of electric power by capturing of energy released by transmutation of one chemical element into another element/s, using any one or more target elements of the periodic table. Target element/s are reacted with paramagnetic and excited state mercury-based compound as source of energy. During the transmutation process, there is energy released in the form of charged particles, X-rays and heat. Released energy is captured and converted for production of electricity to meet demand supply gap of electricity and for providing better quality of life for masses and other applications of electricity and fuel for transportation.

The method, apparatus, device, and system referred to herein as a Electric Power Generation System, preferably includes a reactor having energy capturing system coupled to the reactor that converts captured energies to electricity.

It is an embodiment, the present disclosure relates to a Electric Power Generation System that captures energy of charged particles, electromagnetic waves, heat, potential energy, resting energy, kinetic energy, energetic particles and packets of energy, created by conversion of one chemical element into another element/s, using any one element or more elements of periodic table, and converts all captured energy into electric power.

It is an another embodiment that the method, apparatus, device, and system referred to herein as a Electric Power Generation System,

It is an another embodiment, the present disclosure relates to a Electric Power Generation System that captures charged particles, which is released by conversion of one chemical element into another element/s, using any one element or more elements of the periodic table, and convert this charged particles energy into electricity.

It is an another embodiment, the present disclosure relates to Electric Power Generation System that captures the energy of electromagnetic waves, which is released by conversion of one chemical element into another element/s, using any one element or more elements of the periodic table, and convert this electromagnetic waves energy into electricity.

It is an another embodiment, the present disclosure relates to a Electric Power Generation System that captures heat, that is generated by conversion of one chemical element into another element/s, using any one element or more elements of the periodic table, and convert this heat energy into electricity.

It is an another embodiment, the present disclosure relates to a Electric Power Generation System that captures kinetic energy, which is released by conversion of one chemical element into another element/s, using any one element or more elements of the periodic table, and convert this kinetic energy into electricity. .

It is an another embodiment, the present disclosure relates to a Electric Power Generation System, where a direct energy conversion system is used to capture the capture charged particles, which is released by conversion of one chemical element into another element/s, using any one element or more elements of the periodic table, and convert it into electric power.

It is an another embodiment, the present disclosure relates to a Electric Power Generation System that captures charged particles, that is released by conversion of one chemical element into another element/s, using any one element or more elements of the periodic table, and direct this charged particles into a high-tech transformer which convert the charged particles energy into electric circuit as electricity.

It is an another embodiment, the present disclosure relates to a Electric Power Generation System that is having photoelectric receptors, which will capture energy of X-rays and convert into electricity.

It is an another embodiment, the present disclosure relates to a Electric Power Generation System that captures charged particles, released by conversion of one chemical element into another element/s, using any one element or more elements of the periodic table, and direct this charged particles into a induction system that will convert charged particles energy into electricity.

It is an another embodiment, the present disclosure relates to a Electric Power Generation System that captures kinetic energy, which is released by conversion of one chemical element into another element/s, using any one element or more elements of the periodic table, and converts kinetic energy into electricity.

It is an another embodiment, the present disclosure relates to a Electric Power Generation System that captures charged particles, released by conversion of one chemical element into another element/s, using any one element or more elements of the periodic table, and fed charged particles into Electrostatic direct collectors that will convert energy into electricity.

It is an another embodiment, the Electrostatic direct conversion uses charged particles motion to make a voltage, this voltage drives electricity in wire, that becomes electric power.

It is an another embodiment, that the Direct conversion techniques can be inductive based on charges in magnetic filed, Electrostatic based on making charged particles work against electric field.

It is an another embodiment, the present disclosure relates to a Electric Power Generation System that captures charged particles, released by conversion of one chemical element into another element/s, using any one element or more elements of the periodic table, and fed this charged particles into a device, that will convert energy into electricity.

It is an another embodiment, the present disclosure relates to a Electric Power Generation System that captures kinetic energy, released by conversion of one chemical element into another element/s, using any one element any one or more elements of the periodic table, and convert kinetic energy into electric power using Steam Cycle.

It is an another embodiment, the present disclosure relates to a Electric Power Generation System that captures kinetic energy, released by conversion of one chemical element into another element/s, using any one element or more elements of the periodic table, and convert kinetic energy into electric power using Non-Steam Cycle.

It is an another embodiment, the present disclosure relates to a Electric Power Generation System that captures photon energy, which is released by conversion of one chemical element into another element/s, using any one element or more elements of the periodic table, which will be converted into electricity using photoelectric receptors.

It is an another embodiment, the present disclosure relates to a Electric Power Generation System that captures charged particles, that is released by conversion of one chemical element into another element/s, using any one element or more elements of the periodic table, and fed charged particles into a Capacitors, that will convert charged particle energy into electricity.

It is an another embodiment, the present disclosure relates to Electric Power Generation System, that captures charged particles, which is released by conversion of one chemical element into another element/s, using any one element or more elements of the periodic table, which will be converted into electricity using microwave technology.

It is an another embodiment, that Electric Power Generation System comprises a chamber, vacuum pump, heating system, crucible to hold elements in solid state, molten state, liquid state, gaseous state and in combination thereof.

It is an another embodiment, that Electric Power Generation System comprises having outlets pipes for gases to be released.

It is an another embodiment, that Electric Power Generation System comprises having inlet pipes for gases to be put inside apparatus.

It is an another embodiment, that Electric Power Generation System comprises having divertors to exhaust the gases .

It is an another embodiment, that Electric Power Generation System comprises cooling system.

It is an another embodiment, that Electric Power Generation System comprises a device , method, apparatus and system, which will capture energy and will convert it into electricity.

It is an another embodiment, that Electric Power Generation System comprises high-tech transformer.

It is an another embodiment, that Electric Power Generation System comprises Electrostatic direct conversion system

It is an another embodiment, that Electric Power Generation System comprises photoelectric receptors.

It is an another embodiment, that Electric Power Generation System comprises induction system.

It is an another embodiment, that Electric Power Generation System comprises Capacitor.

It is an another embodiment, that Electric Power Generation System comprises Microwave technology.

It is an another embodiment, that Electric Power Generation System comprises energy measuring devices

It is an another embodiment, that Electric Power Generation System comprises gas measuring devices.

It is an another embodiment, that Electric Power Generation System comprises divertor ports

It is an another embodiment, that Electric Power Generation System comprises heating system for melting of any one or more elements of the periodic table.

It is an another embodiment, that Electric Power Generation System comprises induction heating system.

It is an another embodiment, that Electric Power Generation System comprises Radio frequency heating system.

It is an another embodiment, that Electric Power Generation System comprises electric heating coils.

It is an another embodiment, that Electric Power Generation System comprises crucible to hold any one of more elements of periodic table.

It is an another embodiment, that Electric Power Generation System comprises any one of more elements of periodic table present in solid state.

It is an another embodiment, that Electric Power Generation System comprises any one of more elements of periodic table present in gaseous state.

It is an another embodiment, that Electric Power Generation System comprises any one of more elements of periodic table present in liquid form.

It is an another embodiment, that Electric Power Generation System comprises any one of more elements of periodic table present in molten state.

It is an another embodiment, that Electric Power Generation System comprises shielding system.

It is an another embodiment, that Electric Power Generation System comprises blanket.

It is an another embodiment, that Electric Power Generation System comprises cooling system.

It is an another embodiment, that Electric Power Generation Syetem comprises heating system/s.

It is an another embodiment, that Electric Power Generation System comprises pressure valve to regulate pressure.

It is an another embodiment, that Electric Power Generation System comprises flow meter to regulate flow of gases and material.

It is an another embodiment, that Electric Power Generation System comprises heat exchanger.

It is an another embodiment, that Electric Power Generation System comprises steam turbine

It is an another embodiment, that Electric Power Generation System comprises power conditioning unit.

It is an another embodiment, that Electric Power Generation System comprises electricity collection coil.

It is an another embodiment, that Electric Power Generation System comprises capacitor bank.

It is an another embodiment, that Electric Power Generation System comprises electrostatic coil.

It is an another embodiment, that Electric Power Generation System comprises ventilation system.

It is an another embodiment, that Electric Power Generation System comprises control system.

It is an another embodiment, that Electric Power Generation System comprises manipulator system.

It is an another embodiment, that Electric Power Generation System comprises shielding system.

It is an another embodiment, that Electric Power Generation System comprises temperature controller and measuring devices.

It is an another embodiment, that Electric Power Generation System comprises heat measuring devices.

It is an another embodiment, that Electric Power Generation System comprises heating arrangements for any one or more elements of periodic table.

It is an another embodiment, that Electric Power Generation System comprises energy measuring devices.

It is an another embodiment, that Electric Power Generation System comprises gas measuring devices.

It is an another embodiment, that Electric Power Generation System comprises safety devices.

It is an another embodiment, that Electric Power Generation System comprises steam cycle and steam generator.

It is an another embodiment, that Electric Power Generation System comprises Non-steam cycle.

It is an another embodiment, that Electric Power Generation System comprises CCTV system.

It is an another embodiment, that Electric Power Generation System comprises cold wall system.

It is an another embodiment, that Electric Power Generation System comprises a conversion system of electromagnetic waves into electricity.

It is an another embodiment, that Electric Power Generation System comprises a Ion thruster, which can convert potential energy into kinetic energy.

It is an another embodiment, that Electric Power Generation System comprises a conversion system of electrostatic motor power and propulsion to convert the potential energy into kinetic energy for production of electricity.

Paramagnetic and excited state Mercury-based Compound is used as a source of energy (Based on Prior art PCT Publication number: WO 2016181204) and reacted with target elements (any one or more elements of the periodic table), for transmutation of target elements and generation of energy, which will be converted into electricity.

Electricity production device of the present invention can be from kilowatts to Gigawatts, but not limited to it. It will be grid and off grid for all kinds of electricity applications such as for Entertainment, Healthcare, Engineering, Transportation, Communication, Outdoors, Residentials, Commercials, Industrials, Agricultures, Desalination of water, Office, Spacecraft, Rockets, fuel for transportation and so on.

Method, Apparatus, Device and System for the Generation of Electricity according to at least one of the preceding items , wherein produced electricity will be utilised for all kinds of electricity applications such as for Residential, Commercial, Industrial, Agriculture, Desalination of water, Office, Sport complex, Entertainment, Medical Hospitals, Engineering, Transportation, Communication, Outdoors, Spacecraft, Rockets, fuel and so on.

1-35. (canceled)

36. An electric power generation system comprising:
a reactor for capturing energy released by a conversion of one or more isotopes of one element or more elements of the periodic table to one or more other isotopes of one or more other element(s);
(ii) a converter coupled to the reactor that is adapted to convert the captured energy into electrical energy; and
(iii) a paramagnetic and excited state mercury-based compound as a source of energy for transmutation of elements and generation of electricity.

37. The system of claim 36, wherein the reactor comprises a nuclear transmutation energy apparatus adapted to provide transmutation of the one or more isotopes of one element or more elements of the periodic table to one or more other isotopes of one or more element(s).

38. The system of claim 37, wherein nuclear transmutation energy apparatus comprises a Paramagnetic and excited state mercury-based compound as a source of energy with target elements which allow transmutation, preferably one or more out of the following group: hydrogen, deuterium, lithium, boron.

39. The system of claim 36, which is adapted to use the elements H, to U and TRU or any of elements of periodic table, its alloy/compound/ salts present in liquid, gaseous or solid or molten state.

40. The system of claim 36 comprising an x-ray energy converter for directly converting x-ray emission into electrical energy comprising: one or more electron emitter layers in electrical communication with one or more electron collector layers, wherein the one or more electron emitter layers adsorbs x-rays and emits electrons that are adsorbed by the one or more electron collector layers.

41. The system of claim 40, wherein the one or more electron collector layers are nested concentrically, and one or more electron collector layers absorb electrons of different energy.

42. The system of claim 40, wherein the one or more x-ray energy converter is nested concentrically to collect x-rays of different energies.

43. The system of claim 40, wherein each of the one or more electrons collector layers are separated by a voltage of between about 15% and about 25% relative to the next electron collector layer.

44. The system of claim 40 comprising an inverse cyclotron energy converter.

45. The system of claim 36 comprising power output electrodes connectable to a transformer.

46. The system of claim 45, wherein said power output electrode is connected to an arc chamber, said arc chamber is used to limit the voltage on the said power output electrodes.

47. The system of claim 46, wherein said arc chamber is connected to a capacitor to store energy from said power output electrodes, said arc chamber arcs at a voltage to discharge the capacitor through the said arc chamber.

48. The system of claim 46, wherein said arc chamber comprises ferrite coil assemblies around the arc chamber to pickup the magnetic field from the arc chamber for conversion to electricity.

49. The system of claim 36, wherein the released energy comprises one or more out of the following group of types of energy: the energy of charged particles, electromagnetic waves, like gamma-rays, X-rays, light and/or radio waves, heat, potential energy, resting energy, kinetic energy, energetic particles and packets of energy.

50. The system of claim 36, wherein the charged particles are directed into one or more of the following subsystems for generation of electrical energy: (i) a high-tech transformer which converts the charged particles energy into electric circuit as electricity, (ii) an induction system adapted to convert charged particles energy into electricity, (iii) Electrostatic direct collectors to convert charged particles energy into electricity, (iv) a wiring system to generate a difference in potential or voltage in the wiring used to generate electrical energy, (v) an inductive direct energy conversion system for generation of electricity by the moving charged particles in the magnetic field, (vi) a capacitor to convert the generated charge into electrical energy, (vii) a microwave system, (viii) a direct energy conversion system adapted to capture the captured charged particles to directly convert the energy of the captured charged particles into electric power.

51. The system of claim 36 which comprises photoelectric receptors, which capture energy of photons of X-rays, gamma rays and/or light and converts the captured energy into electricity.

52. The system of claim 36 which is adapted to convert kinetic energy into electric energy and comprises (i) a steam cycle system or (ii) a non-steam cycle system.

53. The system of claim 36 which comprises one or more of the following elements: a chamber, vacuum pump, heating system, crucible to hold elements in solid state, molten state, liquid state, gaseous state and in combination thereof; outlets pipes for gases to be released; inlet pipes for gases to be fed to the system; divertors to exhaust the gases; a cooling system; an electrical generator; a high-tech transformer; an electrostatic direct conversion system; photoelectric receptors; an induction system; a capacitor; a microwave converter system; energy measuring devices; gas measuring devices; divertor ports; a heating system for melting of any one or more elements of the periodic table; an induction heating system; a radio frequency heating system; electric heating coils; crucible to hold any one or more elements of the periodic table in solid state, in gaseous state, in liquid form, in molten state; paramagnetic and excited state mercury-based compound as a source of energy for transmutation of target elements; a shielding system; a blanket; a cooling system; one or more heating system/s; pressure valves to regulate the pressure; a flow meter to regulate the flow of gases and material; a heat exchanger; a steam turbine; a power conditioning unit; an electricity collection coil; a capacitor bank; an electrostatic coil; a ventilation system; a control system; a manipulator system; a shielding system; temperature controller and measuring devices; heat measuring devices; heating arrangements for any one or more elements of periodic table; energy measuring devices; gas measuring devices; safety devices; a steam cycle system and a steam generator; a non-steam cycle system; a CCTV system; a cold wall system; a conversion system of electromagnetic waves into electricity; an ion thruster, which can convert potential energy into kinetic energy; and/or a conversion system of electrostatic motor power and propulsion to convert the potential energy into kinetic energy for the generation of electrical energy.

54. An inverse cyclotron energy converter adapted to be used in an electric power generation system of claim 36, said converter comprising first and second electrodes forming a tapered cylindrical cavity, the electrodes being in spaced relation forming first and second elongate gaps there between, a magnetic field generator extending about the first and second electrodes, and a charged particle collector positioned at one end of the first and second electrodes.

55. The converter of claim 54 further comprising an electron collector positioned adjacent another end of the first and second electrodes.

56. The converter of claim 55, wherein the electron collector is annular in shape.

57. The converter of claim 55, wherein the electron collector and ion collector are electrically coupled.

58. The converter of claim 54, further comprising a tank circuit coupled to the first and second electrodes.

59. The converter of claim 54, wherein the magnetic field generator comprises a plurality of field coils extending about the first and second electrodes.

60. The converter of claim 54, wherein the first and second electrodes are symmetrical.

61. An inverse cyclotron energy converter adapted to be used in an electric power generation system of claim 54, comprising a plurality of electrodes forming an elongate cavity, the electrodes being in spaced relation forming first and second elongate gaps there between, and a magnetic field generator extending about the plurality of electrodes.

62. The converter of claim 61, further comprising an ion collector positioned at first end of the plurality of electrodes, and an annular shaped electron collector positioned adjacent a second end of the plurality of electrodes, the electron and ion collectors being electrically coupled to one another.

63. The converter of claim 61, further comprising a tank circuit coupled to the plurality of electrodes.

64. The converter of claim 61, wherein the magnetic field generator comprises a plurality of field coils extending about the plurality of electrodes.

65. The converter of claim 54, wherein the plurality of electrodes is tapered.

66. A method of converting transmutation energy into electric energy, in particular in an electric power generation system of any one of claim 36, said method comprising the following steps:
(i) capturing energy released by a conversion or transmutation of one or more isotopes of one element or more elements of the periodic table to one or more other isotopes of one or more other element(s),
(ii) converting the captured energy into electric energy, and
(iii) a paramagnetic and excited state mercury-based compound as a source of energy for transmutation of elements and generation of electricity.

67. The method of claim 66 comprising a step for directly converting x-ray emission into electrical energy.

68. The method of claim 66, further comprising the step of decelerating charged particles.

69. The method of claim 66, further comprising the step of collecting the charged particles once a substantial portion of their kinetic energy is converted to electric energy.

70. The method of claim 66, further comprising the step of conditioning the electric energy converted from the ion energy to match existing power grids.
